(19) United States
(12) Patent Application Publication
(10) Pub. No.: US 2002/0147682 A1
(43) Pub. Date: Oct. 10, 2002

(54) Automated payment retrieval system and method

(76) Inventors: Stephen J. Price, Frederick, MD (US); Jane M. Price, Frederick, MD (US)

Correspondence Address: Richard C. Litman, LITMAN LAW OFFICES, LTD., P.O. Box 15035, Arlington, VA, 22215, US

(21) Appl. No.: 10/095,530

(22) Filed: Mar. 13, 2002

Related U.S. Application Data
(60) Provisional application No. 60/282,471, filed on Apr. 10, 2001.

(51) Int. Cl. G06F 17/60

(52) U.S. Cl. 705/40; 705/39

(57) ABSTRACT

An automated payment retrieval system for managing payment retrievals and processing for a plurality of customers that is made up of a plurality of primary servers and back up servers for responding to commands from a plurality of customers, a central processing unit (CPU) for interpreting and executing instructions, a plurality of dialogic analog cards for receiving and transmitting inbound and outbound telephone calls for the system, a plurality of databases for storing information about customer lists, customers' American Banking Association (ABA) numbers, delinquent customer lists and sales customers' lists, interactive voice response (IVR) software for processing inbound and outbound telephone calls, automated clearing house (ACH) software for processing information sent to and received from an automated clearing house (ACH), a pretty good privacy (PGP) server and program for public key encryption and credit card verification and processing software. Several methods are also incorporated with the system for both inbound and outbound customers.

### CROSS-REFERENCE TO RELATED APPLICATION

This application claims the benefit of U.S. Provisional Patent Application Serial No. 60/282,471, filed Apr. 10, 2001.

### BACKGROUND OF THE INVENTION

1. Field of the Invention

The present invention relates to an automated payment system and method for managing payment retrievals and processing.

2. Description of Related Art

The Internet has dramatically changed the way people shop and pay for merchandise. Combined with telephony and database technology, customers are given a high level of convenience to shop and submit payments with a greater level of ease than ever before. This higher level of convenience is reflected in the related art.

U.S. Pat. No. 5,283,829 issued to Anderson, outlines the use of an electronic bill payment system and method for creating approval records and generating approval numbers for each pre-authorized subscriber. The system also includes an interactive payment approval apparatus into which subscribers dial to approve payment and determine, based upon information collected, whether to initiate an electronic funds transfer. An approval record database and call history log database are also part of the system.

U.S. Pat. No. 5,383,113 issued to Kight et al., outlines the use of a computerized payment system by which a consumer may instruct a service provider by telephone, computer terminal or other telecommunications device. This allows a consumer to pay various bills without the consumer having to write a check for each bill. The system, used by a service provider, collects consumers' information, financial institutions' information and merchant information and arranges payment to the merchants according to the consumers' instructions based on a financial risk analysis.

U.S. Pat. No. 5,679,940 issued to Templeton et al., outlines the use of a check acceptance system, and relates more particularly to methods and systems for interactive check authorizations using an electronic transaction terminal for acquiring transaction data directly at the point of sale.

U.S. Pat. No. 5,727,249 issued to Pollin, outlines the use of a system and method of collecting payments, to generate a draft, payable to a creditor and drawn on a payor's checking account, pursuant to the payor's authorization. The draft is then executed by the debt collector as authorized signatory for the payor, an deposited into the payee's account to complete payment.

U.S. Pat. No. 5,822,737 and U.S. Pat. No. 5,991,738 issued to Ogram, outline an automated payment system particularly suited for purchases over a distributed computer network such as the Internet. In such a distributed computer network, a merchant or vending computer contains certain promotional information which is communicated to a customer's computer. The system also relates more particularly to transactions involving credit or debit cards.

U.S. Pat. No. 5,832,463 issued to Funk, outlines the use of a document handling system. More particularly, the invention if related to an automated system and method for checkless check transactions. The check processing system and method includes a data entry device for receiving checking account information and a check amount of a check provided in a transaction. The transaction may take place at a bank teller window or at the point of sale.

U.S. Pat. No. 5,870,456 issued to Rogers, outlines the use of electronic payment systems and, more particularly, to a universal, real-time bill payment system and method. The system and method uses automated teller machine (ATM) debit cards without the requirement of a personal identification number (PIN) . This is done in conjunction with touch tone telephones to initiate consumer bill payments electronically and to provide for the elimination of paper checks and the use of the automated clearing house of the U.S. banking system to settle individual items.

U.S. Pat. No. 5,884,288 issued to Chang et al., outlines the use of a method and system for providing a fully automated electronic bill processing capability that is integrated with banking institutions and their customers. The electronic bill payment system includes a community of payers, payees, payor banks and payee banks that are associated with computing systems that are interconnected by a computer network.

Each of the systems and methods outlined in each of the patents described herewithin are useful in improving the use of the Internet, telephony systems and database technology for managing payment retrievals. None of these systems and methods, however, has the capability to negotiate and make actual payment arrangement details, which is something that would be very valuable to customers utilizing these technologies.

None of the above inventions and patents, taken either singly or in combination, is seen to describe the instant invention a claimed.

### SUMMARY OF THE INVENTION

An automated payment retrieval system for managing payment retrievals and processing for a plurality of customers that is made up of a plurality of primary servers and back up servers for responding to commands from a plurality of customers, a central processing unit (CPU) for interpreting and executing instructionss, a plurality of dialogic analog cards for receiving and transmitting inbound and outbound telephone calls for the system, a plurality of databases for storing information about customer lists, customers' American Banking Association (ABA) numbers, delinquent customer lists and sales customers lists, interactive voice response (IVR) software for processing inbound and outbound telephone calls, automated clearing house (ACH) software for processing information sent to and received from an automated clearing house (ACH), a pretty good privacy (PGP) server and a program for public key encryption and credit card verification and processing software. Several methods are incorporated with the system for both inbound and outbound customers.

Accordingly, it is a principal object of the invention to handle both inbound and outbound collections calls.

It is another object of the invention to place outbound calls with payment negotiation to create an automated customer service representative and payment retrieval device.

It is a further object of the invention to collect check and credit card payments as well as promises to pay.

It is a further object of the invention to allow for greater use of customer service representatives' time.

It is a further object of the invention to decrease costs for collection.

Still another object of the invention is to provide account balance, last payment and next payment inquiries.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an overview of the system, according to the present invention.

FIG. 2 is an overview of an inbound customer's start of a communications session.

FIG. 3 is a validation of a phone number from an inbound customer's communication session.

FIG. 4 is a selection of a payment arrangement from an inbound customer's communication session.

FIG. 5 is an entering of a payment amount from an inbound customer's communication session.

FIG. 6 is an offering of a minimum payment from an inbound customer's communication session.

FIG. 7 is a selection of a payment method from an inbound customer's communication session.

FIG. 8 is an outline of a method of payment by credit card from an inbound customer.

FIG. 9 is the entering of an expiration date for a credit card from an inbound customer.

FIG. 10 is an outline of a method of payment by check from an inbound customer.

FIG. 11 is an entering of an account number for a check for payment by an inbound customer.

FIG. 12 is an outline of a payment recap for an inbound customer.

FIG. 13 is an outline of the steps involved with a payment confirmation from an inbound customer.

FIG. 14 is an outline of the steps involved with arranging a payment for an inbound customer.

FIG. 15 is an outline of the steps involved with making a minimum payment for an inbound customer.

FIGS. 16A-16B are an outline of the steps involved with negotiating a minimum payment for an inbound customer.

FIGS. 17A-17B are an outline of the steps involved with setting a payment date for an inbound customer.

FIGS. 18A-18B are an outline of the steps involved with performing a payment confirmation for an inbound customer.

FIG. 19 is an outline of the steps involved with getting a balance due amount for an inbound customer.

FIG. 20 is an outline of the steps involved with confirming an already sent payment for an inbound customer.

FIG. 21 is an outline of the steps involved in getting a date of payment for an inbound customer.

FIG. 22 is an outline of the steps involved with getting a paid confirmation for an inbound customer.

FIG. 23 is an outline of the steps involved with getting account information for an inbound customer.

FIG. 24 is an outline of the steps involved with the selecting of a payment method by an inbound customer.

FIG. 25 is an outline of the steps involved with the payment by credit card by an inbound customer.

FIG. 26 is an outline of the steps involved with the payment by check by an inbound customer.

FIGS. 27A-27B are an outline of the steps involved with entering a payment amount by an inbound customer.

FIGS. 28A-28B are an outline of the steps involved with performing a payment confirmation by an inbound customer.

FIG. 29 is an outline of the steps involved with ending a call by an inbound customer.

FIG. 30 is an outline of the steps involved with conducting a service call on an outbound customer.

FIG. 31 is an outline of the steps involved with conducting the start of a service call on an outbound customer.

FIG. 32 is an outline of the steps involved with contacting an incorrect party on a service call on an outbound customer.

FIG. 33 is an outline of the steps involved with a service call reaching an outbound customer's answering machine.

FIGS. 34A-34B are an outline of the steps involved with confirming a service call date for an outbound customer.

FIGS. 35A-35B are an outline of the steps involved with changing a service call date for an outbound customer.

FIG. 36 is an outline of the steps involved with obtaining missing information from an outbound customer.

FIG. 37 is an outline of the steps involved with conducting collections call on an outbound customer.

FIG. 38 is an outline of the steps involved with starting collections call on an outbound customer.

FIG. 39 is an outline of the steps involved with reaching wrong outbound customer on a collections call.

FIG. 40 is an outline of the steps involved with reaching an outbound customer's answering machine on a collections call.

Similar reference characters denote corresponding features consistently throughout the attached drawings.

### DETAILED DESCRIPTION OF THE PREFERRED EMBODIMENT

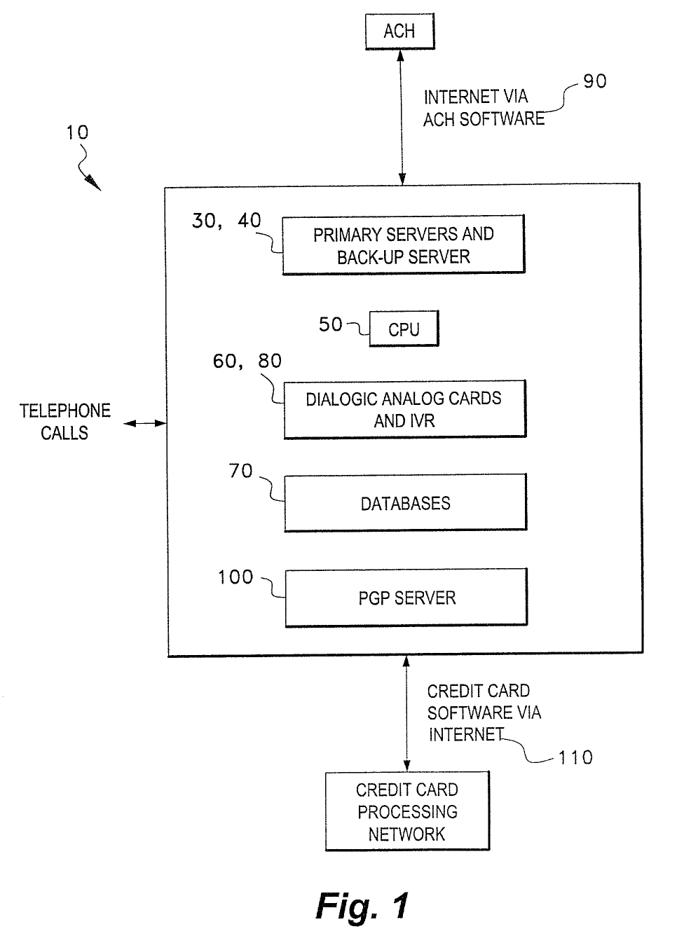

The present invention is an automated payment retrieval system 10 for managing payment retrievals and processing for a plurality of customers 20. Details of the system 10 are depicted in FIG. 1. These details comprise: a plurality of primary servers 30 and back up servers 40 for responding to commands from a plurality of customers 20, a central processing unit (CPU) 50 for interpreting and executing instructions, a plurality of dialogic analog cards 60 for receiving and transmitting inbound and outbound telephone calls for the system 10 and a plurality of databases 70 for storing information about inbound direct pay applications for customer lists and customers' American Banking Association (ABA) numbers and outbound direct pay applications for delinquent customer lists and sales customers lists.

The system 10 also utilizes various software, which include interactive voice response (IVR) software 80 for processing inbound and outbound telephone calls, automated clearing house (ACH) software 90 for processing information sent to and received from an automated clearing house (ACH), a pretty good privacy (PGP) server and program for public key encryption 100 and credit card verification and processing software 110. All of the software and hardware described are well-known to those schooled in the related art and are not a point of novelty with this invention.

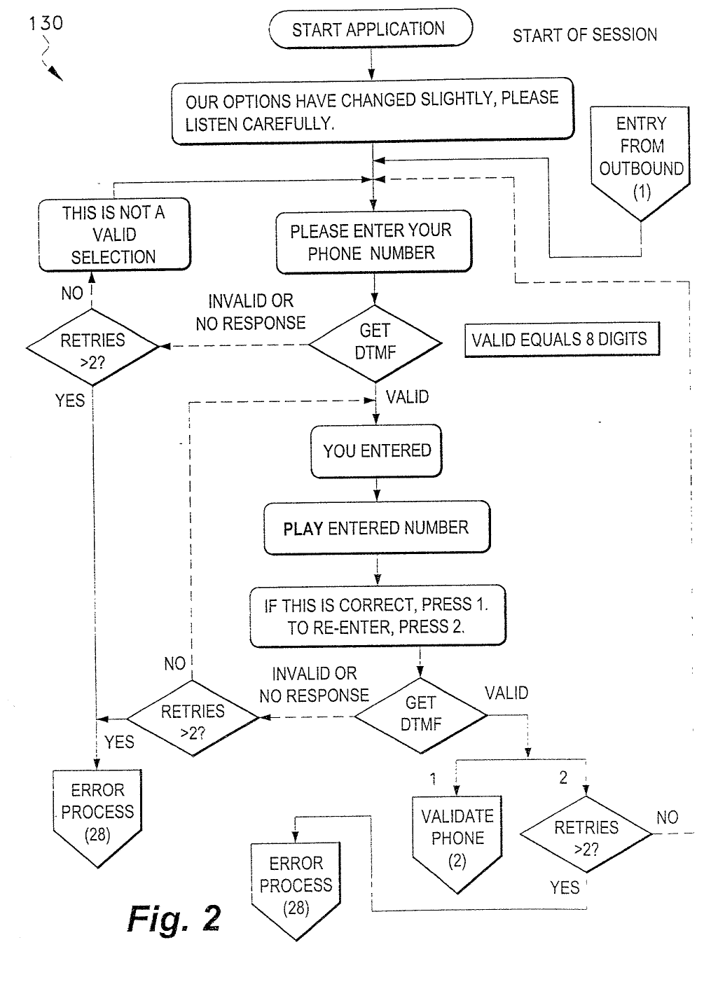

An automated payment retrieval method for managing payment retrievals and processing for an inbound calling customer, is outlined in FIGS. 2-29. An inbound calling customer would be someone who telephoned into the system 10 from outside the system 10 with a customer service or sales question that could be answered using the system 10. More sophisticated questions and problems can be directed to a qualified customer service representative, thereby freeing up the customer service representative to handle only these more sophisticated questions, as opposed to more basic questions being handled by the system 10 itself.

The inbound calling customer method comprises the steps of: starting an inbound communication session, validating an inbound calling customer's telephone number, selecting a payment method and a payment amount, entering a minimum payment amount, paying by credit card or paying by check, summarizing a payment recap, negotiating and arranging a payment schedule, providing a payment confirmation, providing customer's account information and terminating the inbound communication session.

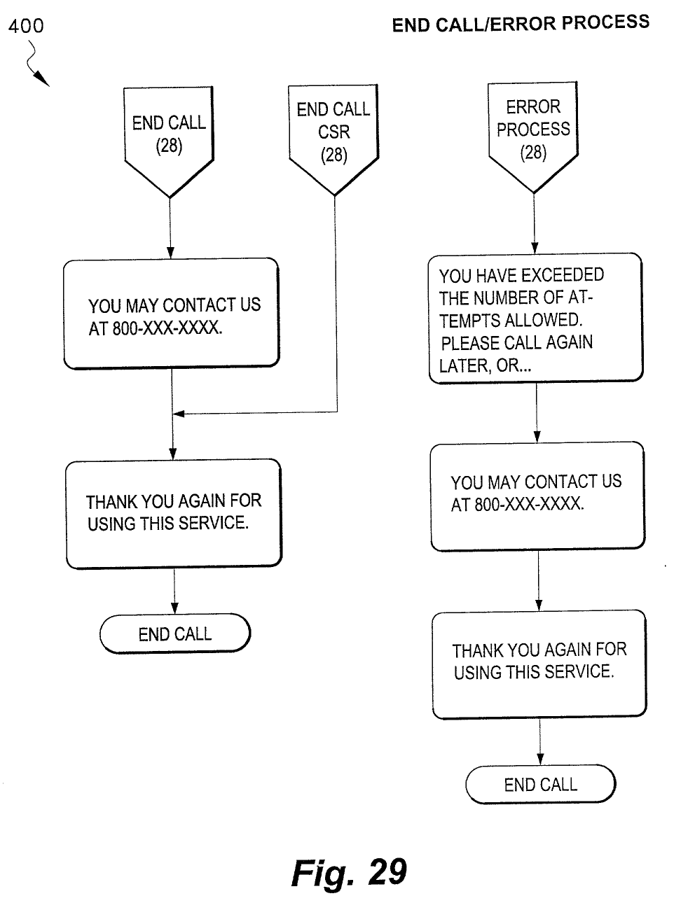

FIG. 2 describes the start of an inbound communications session 130. This pertains to a customer 20 who telephones into the system 10, typically with a customer service question or with a desire to place an order. The customer 20 will call into the system 10 using a 1-800 number and is received by the IVR portion of the system 80. The customer 20 will enter his telephone number using a dual tone multi-frequency (DTMF) signaling capabilities of a touch tone telephone. If there are over two retries, an error signal is generated. Details of the error signal are outlined in FIG. 29.

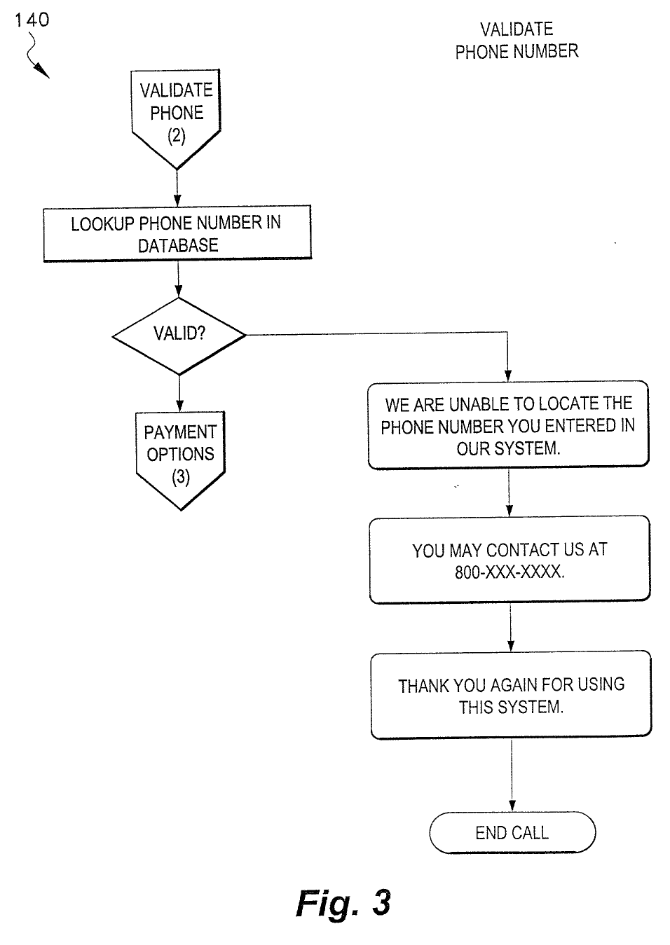

The entered telephone number is then validated 140 using the steps outlined in FIG. 3. The system 10 simply looks up the telephone number entered in the inbound customer list in the database 70. If the number is valid, the customer 20 is forwarded to the payment options menu. If the number is not valid, a message is played to the customer 20 indicating that the telephone number is unable to be located in the system 10 and the call will be ended.

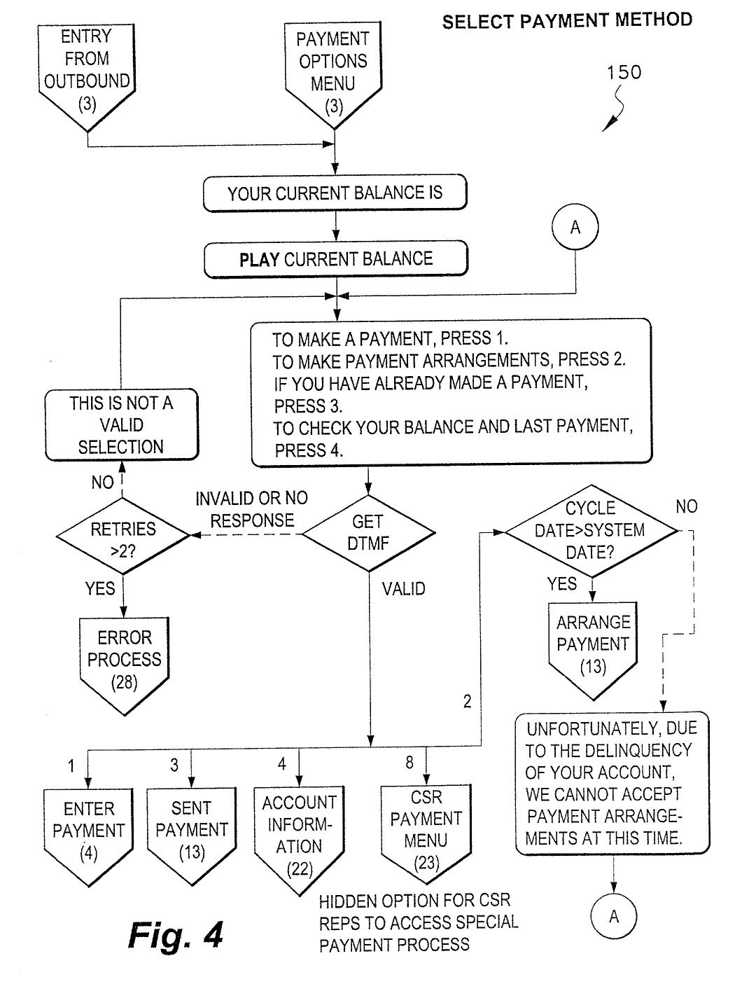

FIG. 4 outlines the options from the payment options menu 150. Options can be selected by using dual tone multi-frequency (DTMF) signals from an ordinary touch tone telephone keypad. A customer 20 can enter a payment, make arrangements for a payment, send payment, get account information and choose a payment type. This can be done by pressing a corresponding number with an option that is indicated to the customer 20 as part of the payment options menu. For example, a customer 20 could press 1 to make a payment, press 2 to make payment arrangements, press 3 to check if a payment has been made or press 4 to check an account balance and last payment. The customer 20 is given two retries in using the system 10 before the call is ended.

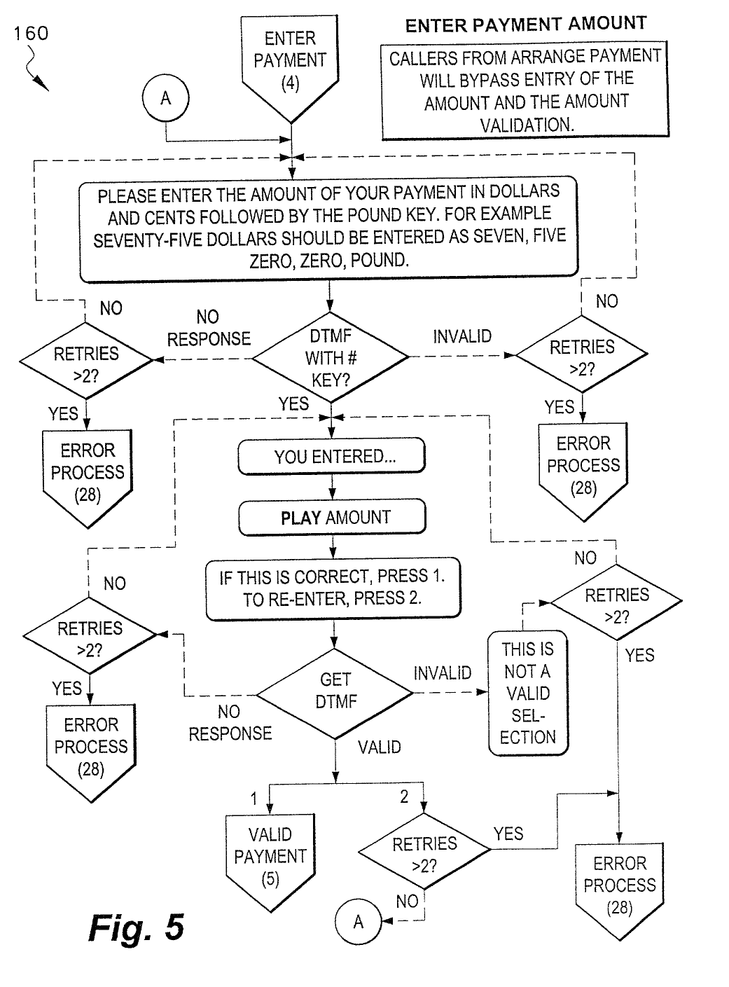

FIG. 5 outlines the process that a customer 20 will undergo to enter a payment amount 160. The customer 20 will punch in the amount of payment being made in dollars and cents followed by the pound key (#), using DTMF/touch tone keys. The payment amount will be repeated to the customer 20, who will confirm the payment amount or re-enter the amount using the appropriate key. Like before, the customer 20 is given two retries before an error message is generated.

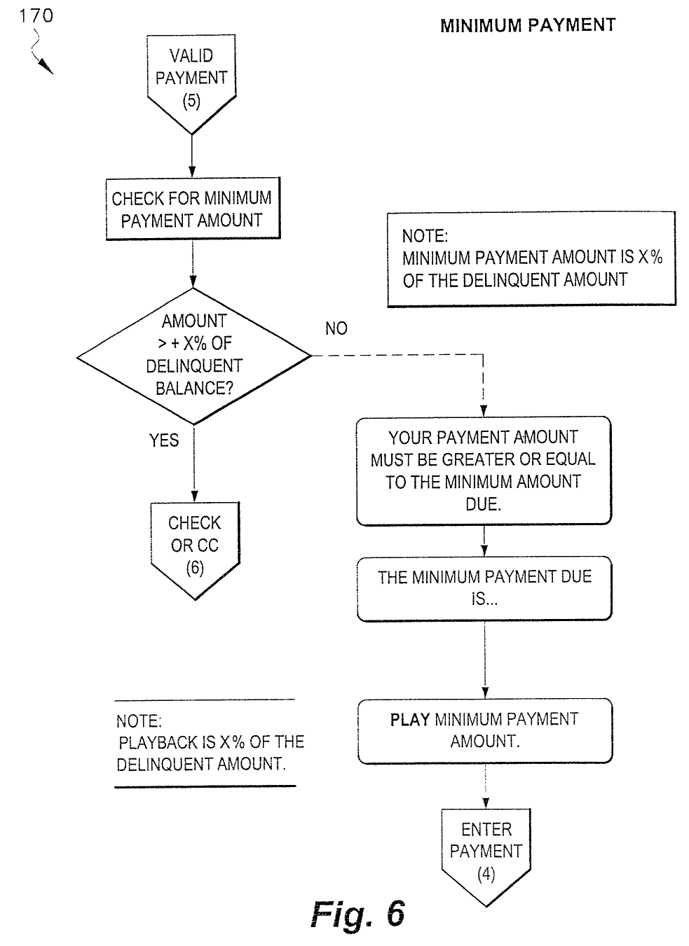

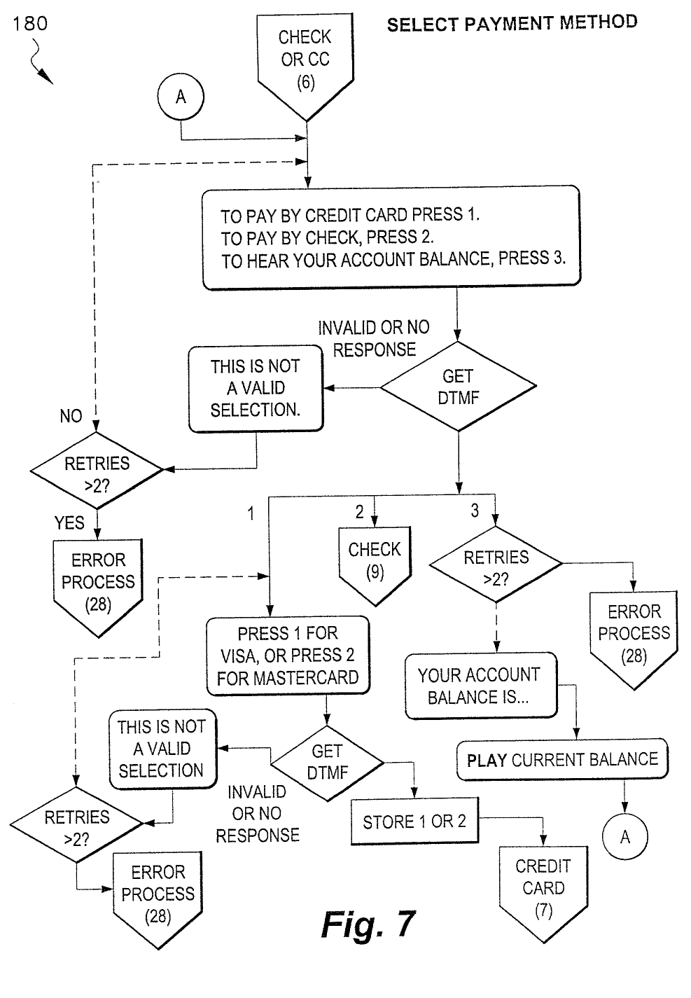

FIG. 6 is an extension of FIG. 5 that gives the minimum payment amount 170 required by the customer 20. This amount is a set percentage that is arbitrarily programmed by the system 10. If the customer 20 pays the minimum payment amount or more, the customer moves on to select a payment method that is outlined in FIG. 7. If the customer 20 enters a payment amount less than the minimum payment, the system 10 indicates to the customer 20 that the payment amount must be greater than or equal to the minimum payment due, and the customer 20 will be asked to re-enter a new payment amount.

The customer 20 than goes to select a payment method 180, the steps of which are outlined in FIG. 7. The customer 20 can indicate which payment amount he would like by selecting a corresponding number for the desired payment method. For example, to pay by credit card, press 1. To pay by check, press 2. To hear your account balance, press 3. If a number is chosen that is not a valid selection, the customer 20 gets two retries before his call is ended.

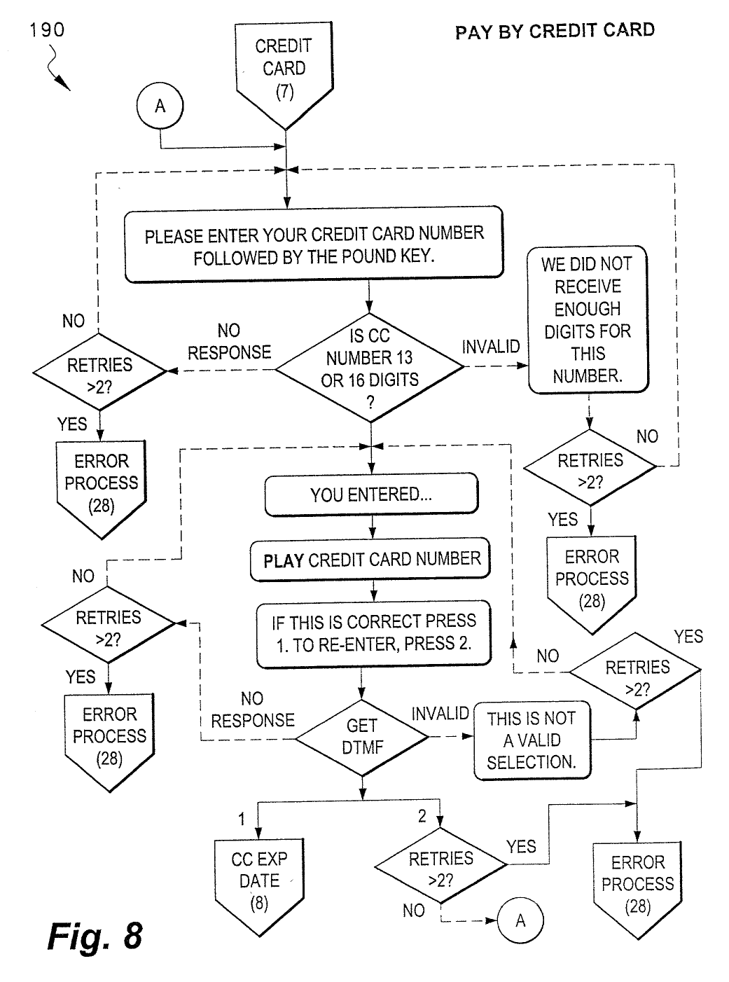

If the customer 20 chooses to pay by credit card 190, as shown in FIG. 8, the credit card must be entered into the system 10 using the keypad on a touch tone telephone and DTMF signal. The customer 20 must indicate if his credit card number is 13 or 16 digits and hear the confirmation playback of the credit card number. If a number is entered that is not a valid number, the customer 20 gets two retries before his call is ended.

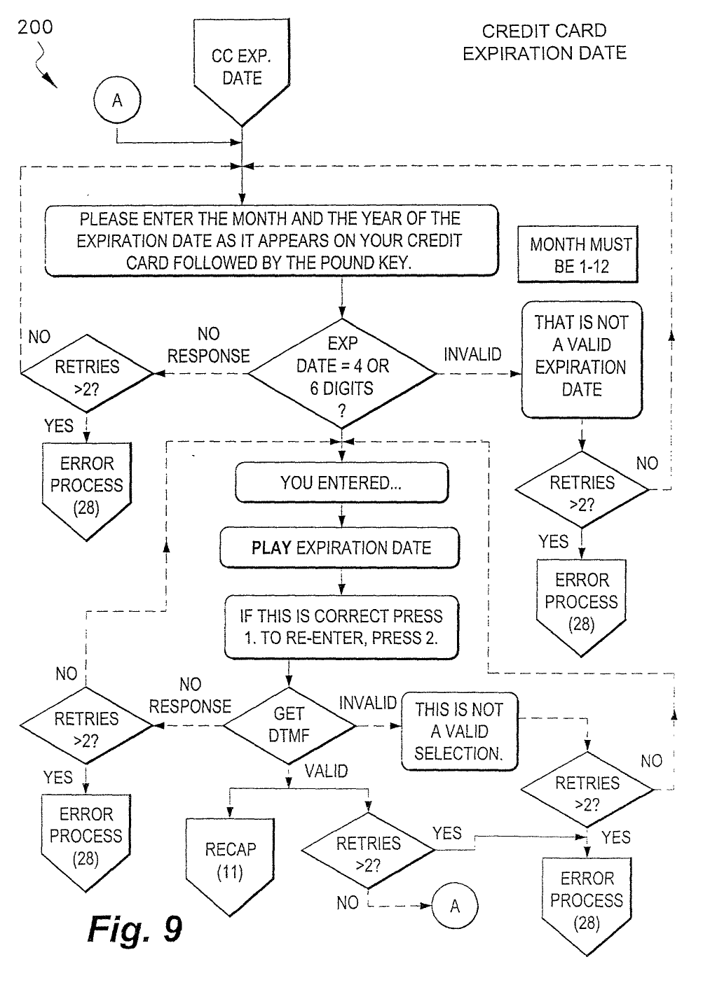

Once completed, the customer 20 is then asked for the expiration date of his credit card number 200 (if he is using it to pay), as shown in FIG. 9. The customer 20 is then asked to enter the month and year of the expiration date, as it appears on the credit card. For example, 0-2-0-3-# is February 2003. The expiration date is repeated for the confirmation playback of the expiration date. If a number is entered that is not a valid number, the customer 20 gets two retries before his call is ended.

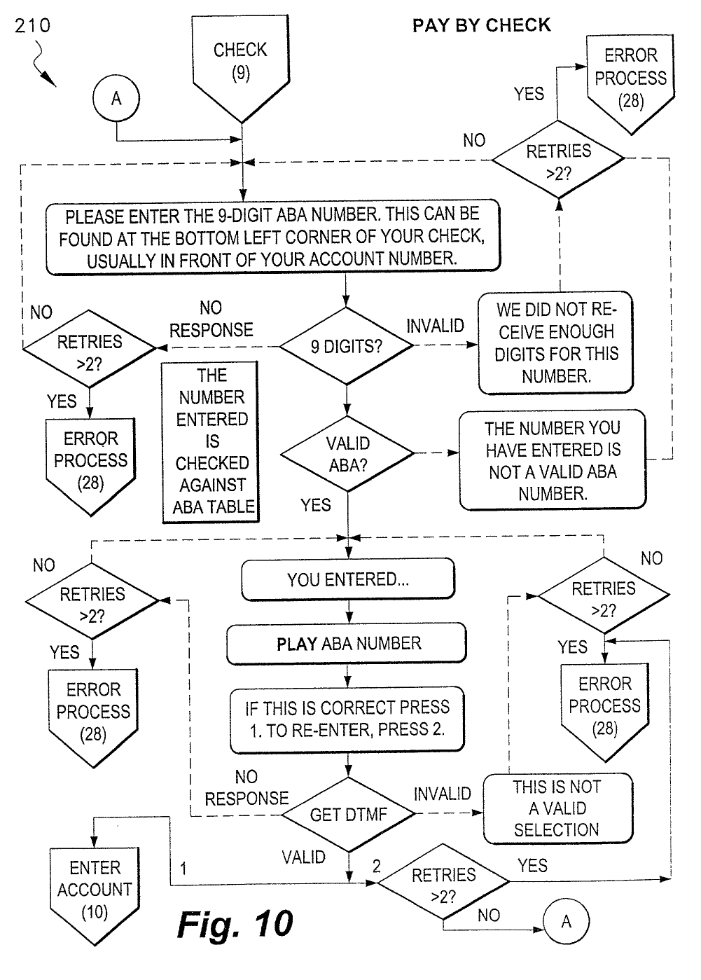

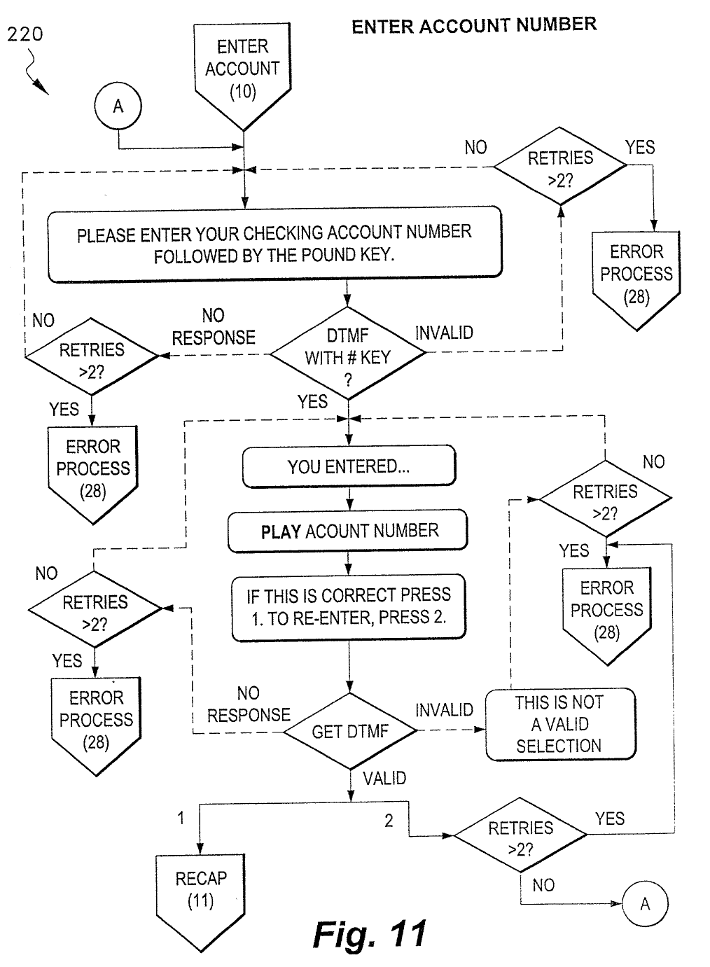

In FIG. 10, if the customer 20 is paying by check 210, he is asked to enter the 9 digit American Banking Association (ABA) number normally found at the bottom left corner of a check, usually in front of the check's account number. The ABA number is repeated by the system 10, for the confirmation playback of the ABA number. If a number is entered that is not a valid number, the customer 20 gets two retries before his call is ended. Similarly, the customer 20 can enter the account number 220 as well, as shown in FIG. 11.

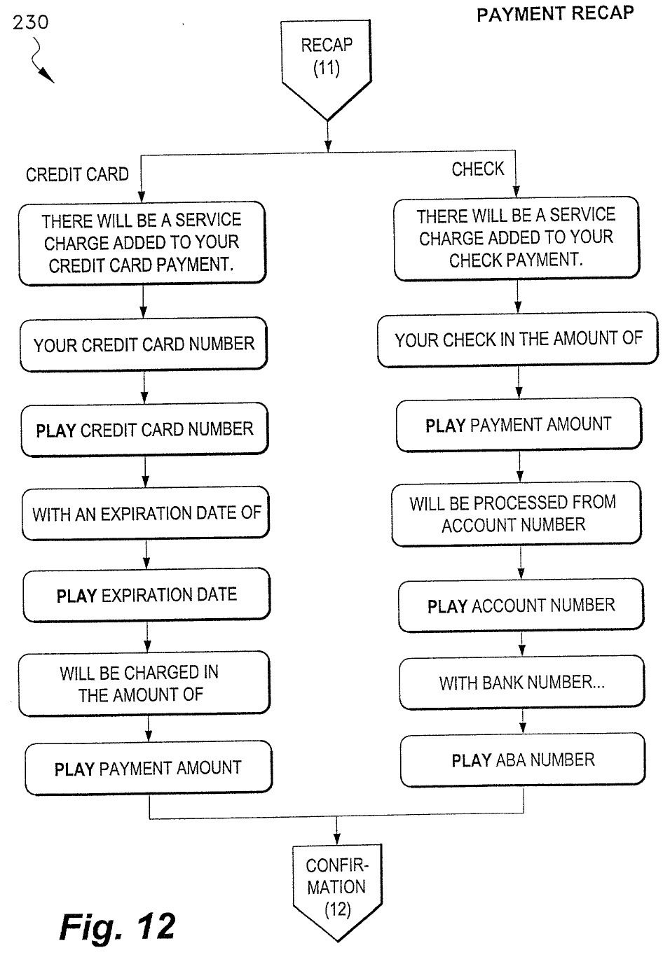

A payment recap 230 is outlined in FIG. 12 for both credit card and checking payments. A service fee is charged to the customer's 20 credit card or checking account and is indicated as such to the customer 20. A recap of the credit card number, expiration date and payment amount is disclosed to a credit card bearing customer 20, while a payment amount, account number and ABA number are disclosed to a customer 20 utilizing his checking account.

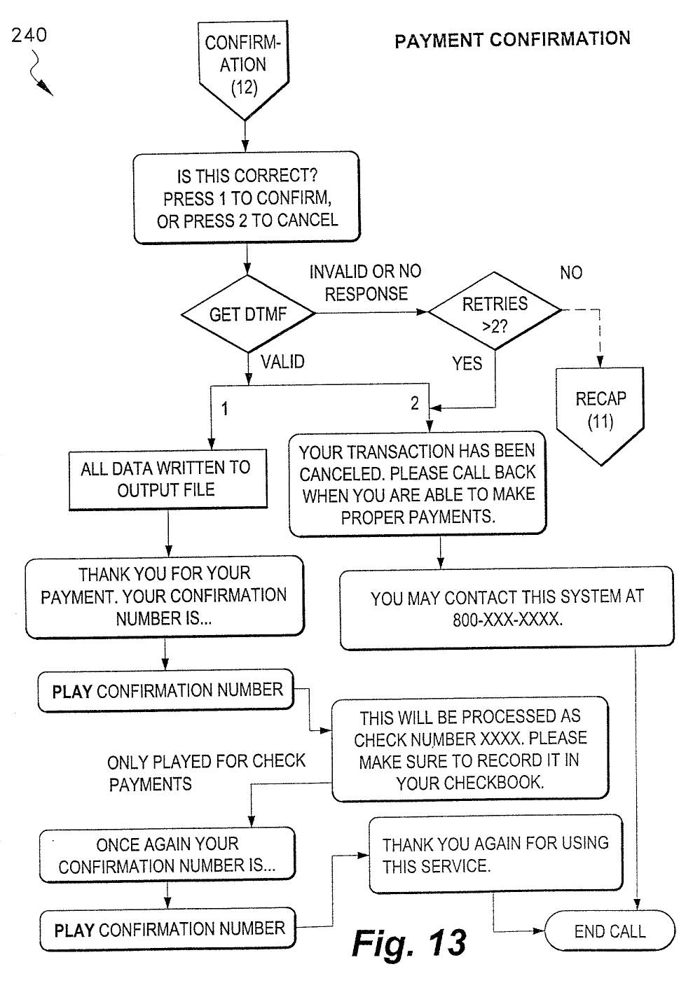

A final confirmation 240 also takes place at the end of the payment recap, as shown in FIG. 13. The customer 20 is asked if the payment recap is correct or if it should be cancelled. If correct, the customer 20 is given a confirmation number, which can be used to verify the completed transaction. The customer 20 is reminded to record the amount of a check (if checking account is used for a transaction) and is thanked for using the system 10. If cancelled, the system 10 indicates to the customer 20 that his transaction is indeed cancelled and that the transaction has ended.

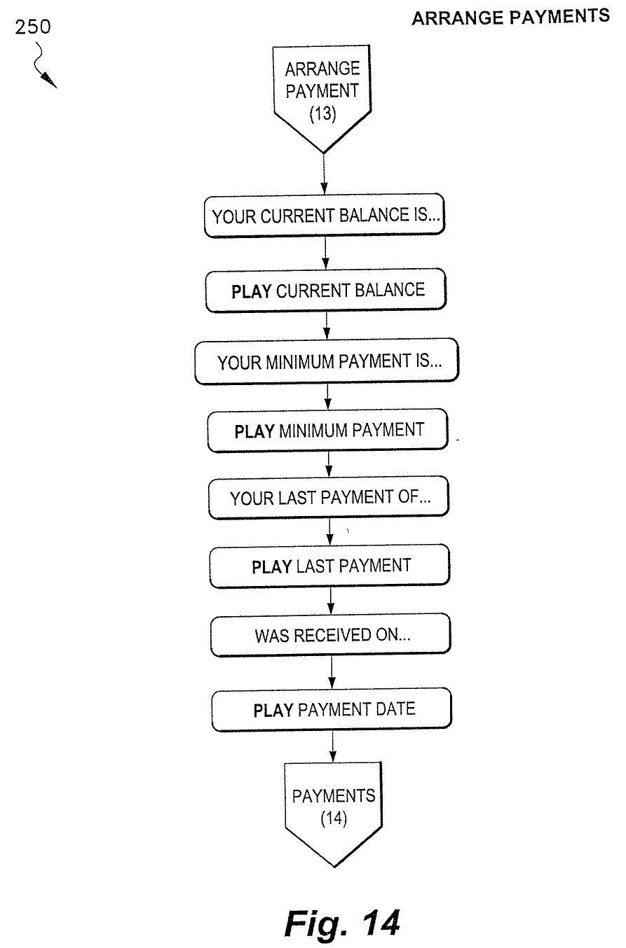

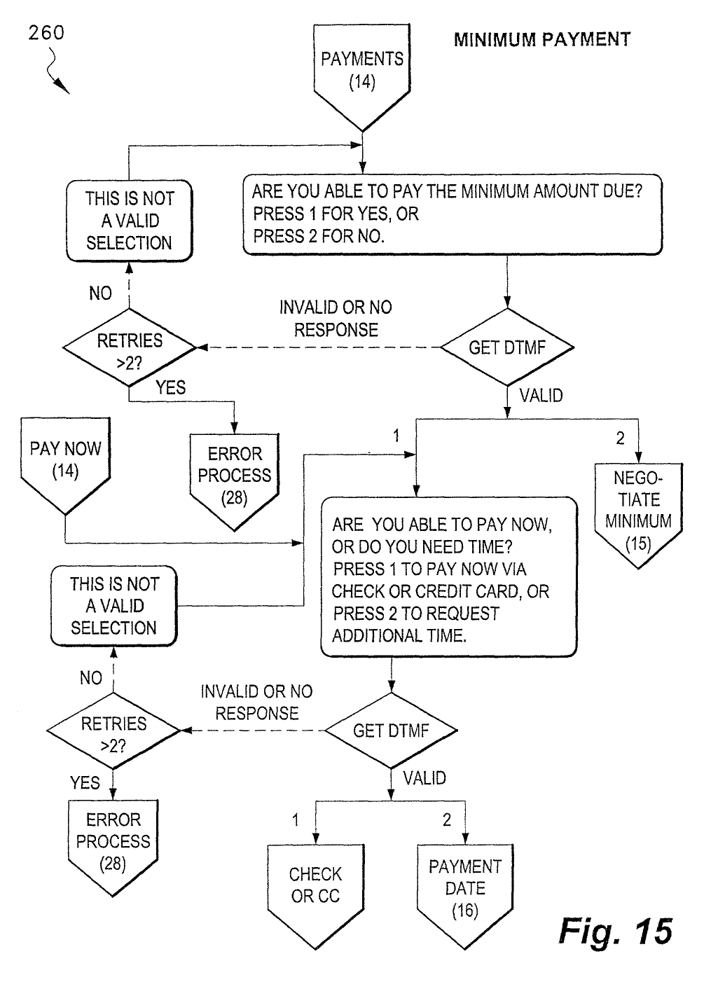

A customer 20 can also make payment arrangements 250, as outlined in FIG. 14. A customer 20 can be provided with the current balance, the minimum payment, the amount of last payment and the date of last payment. FIG. 14 naturally runs into FIG. 15, which outlines the steps for making a minimum payment 260. The customer 20 is asked if he is able to make the minimum amount due. If he cannot, the customer 20 has the chance of negotiating a minimum payment. If the minimum payment is able to be paid, the system 10 asks if the customer 20 is able to pay now, or if more time is needed to make the payment. The customer 20 is also asked if the payment can be made now via check or credit card. This selection is done with a DTMF keypad by selecting 1 or 2. If a number is entered that is not a valid number, the customer 20 gets two retries before his call is ended.

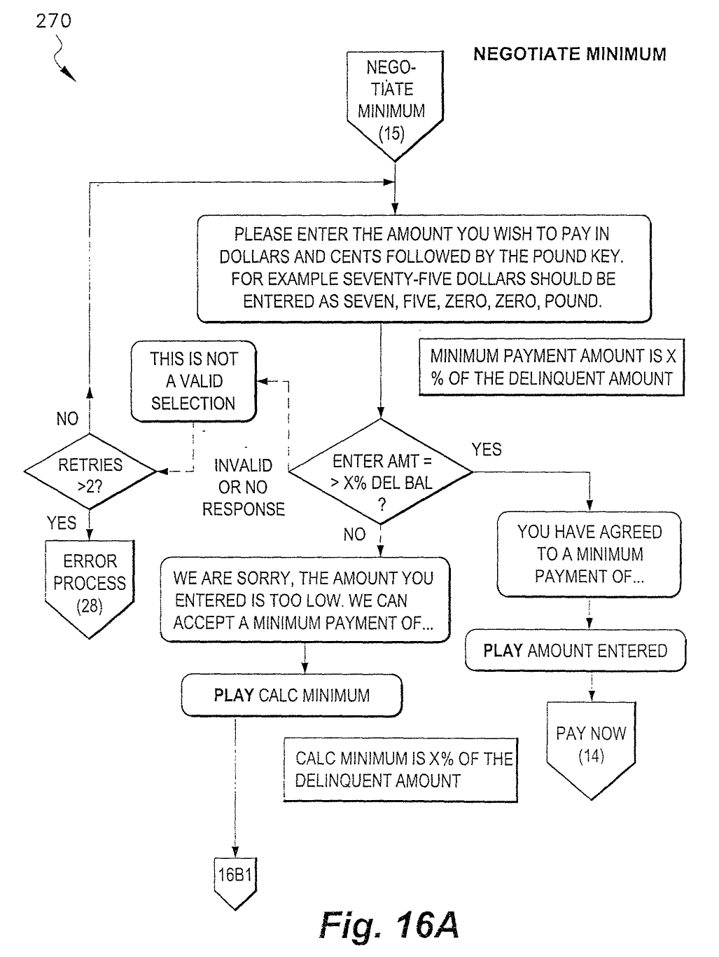

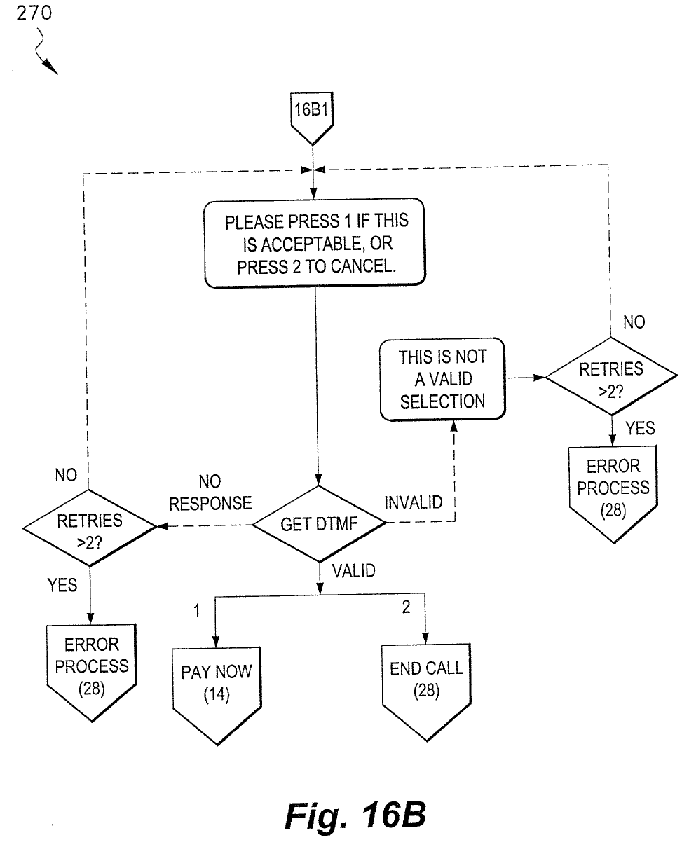

To negotiate a calculated minimum payment 270, the customer 20 must enter the amount that he wishes to pay in dollars and cents followed by the pound key, as shown in FIGS. 16A-16B. For example, seventy five dollars should be entered as 7-5-0-0-#. Note that a calculated minimum payment is an arbitrary percentage of the delinquent amount owed and that an acceptable amount of a calculated minimum payment can also be more than the arbitrary percentage.

The customer 20 can then enter an amount that he wishes to pay 280, which is compared to the calculated minimum payment. If it is equal to or greater than the calculated minimum payment, the system 10 indicates to the customer 20 that an acceptable minimum payment is entered and that the customer 20 must then confirm that this is acceptable (using an appropriate DTMF signal). If the customer 20 enters an amount that he wishes to pay, and that amount is less than the calculated minimum payment, then the system 10 indicates to the customer 20 that the amount entered is too low and that a acceptable amount is the calculated minimum payment. If a number is entered that is not a valid number, the customer 20 gets two retries before his call is ended.

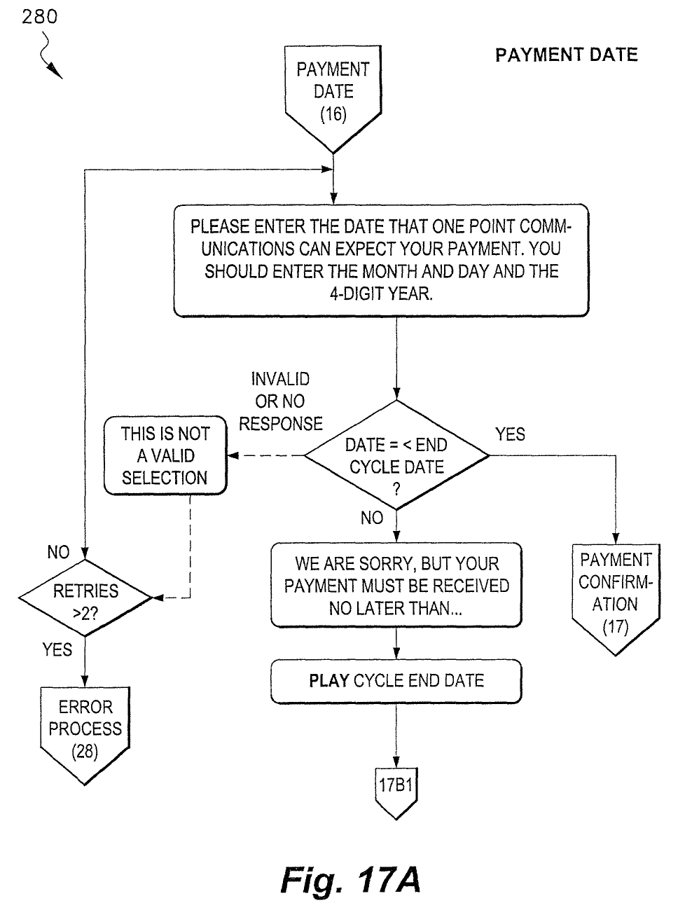

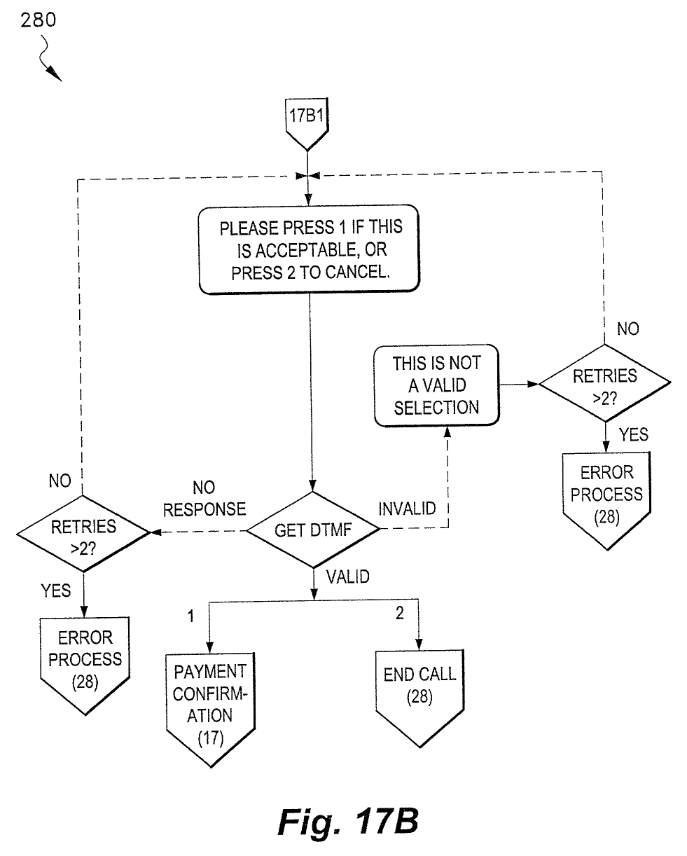

The customer 20 then can set a payment date 280 using the steps outlined in FIGS. 17A-17B. This is similar to the steps taken in FIGS. 16A-16B to negotiate a minimum payment. A customer 20 can enter a date for the system 10 to expect a payment, which should be a 2 digit month and day and a 4 digit year. For example, 0-2-0-2-2-0-0-3 is Feb. 2, 2003. The entered date must be before the calculated cycle date predetermined by the system 10. If it is, then the payment date is confirmed by the customer 20 using a DTMF and a touch pad telephone. If a number is entered that is not a valid number, the customer 20 gets two retries before his call is ended.

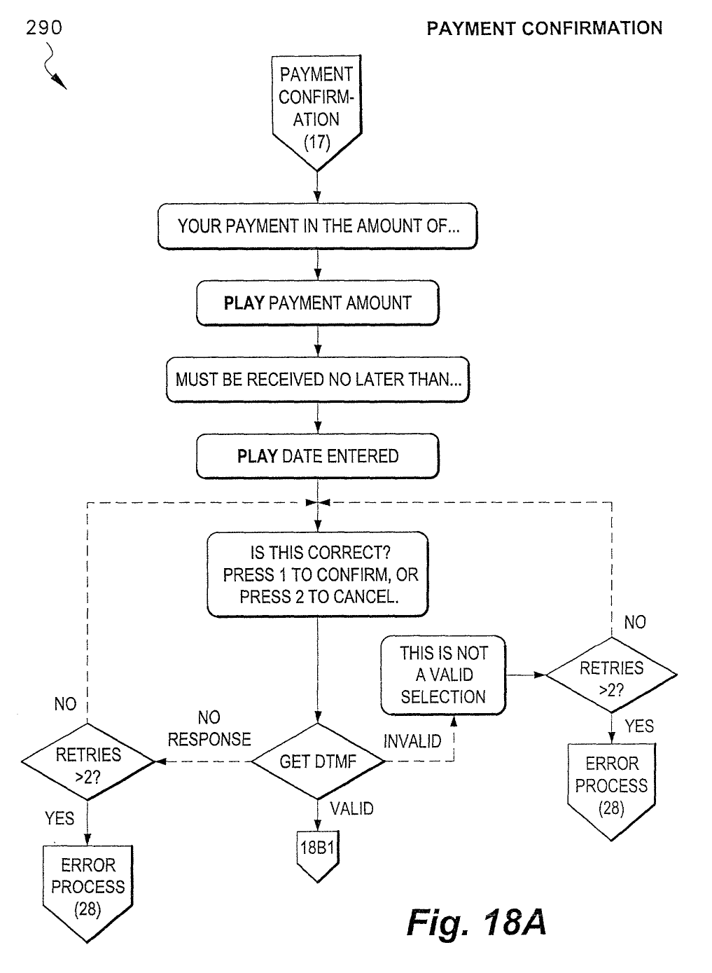

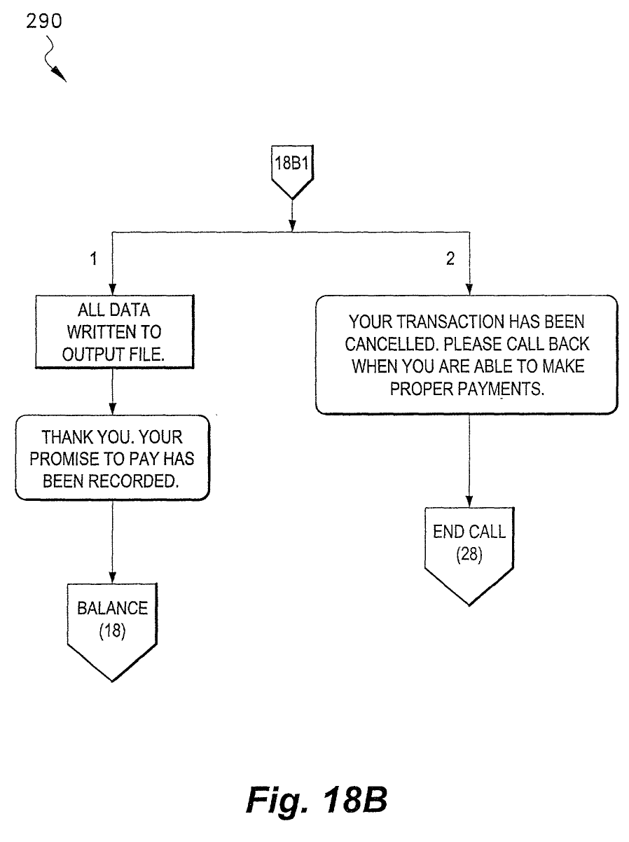

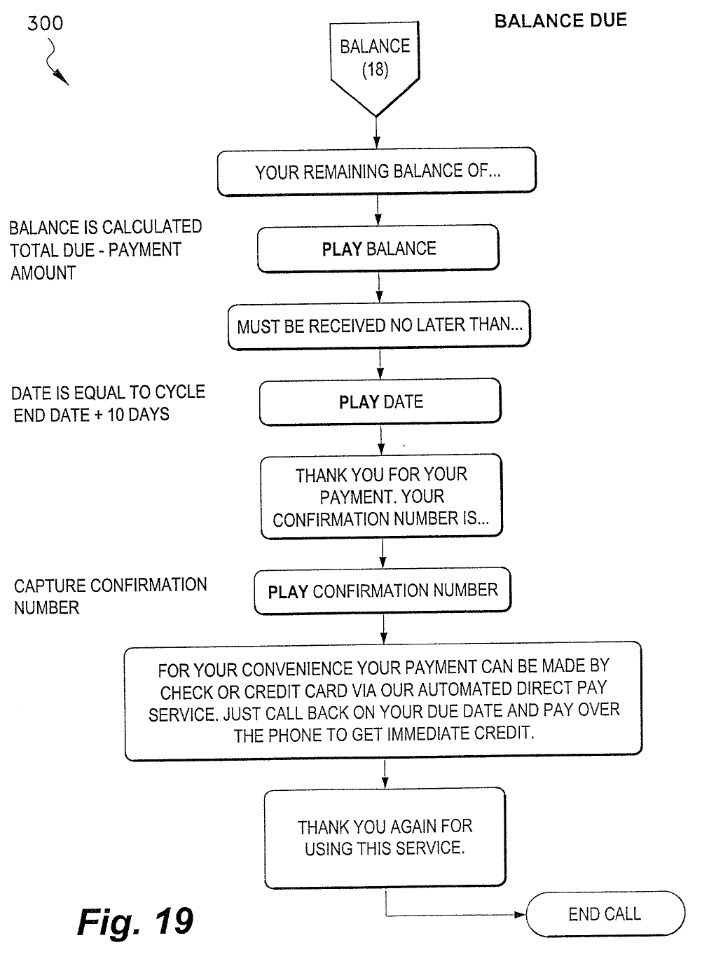

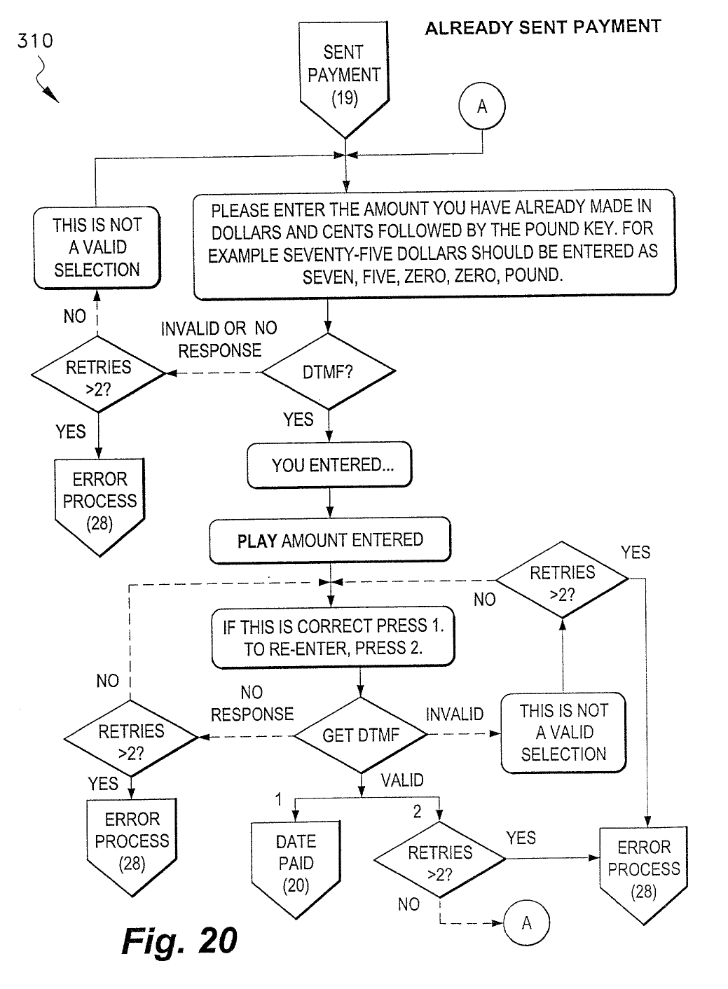

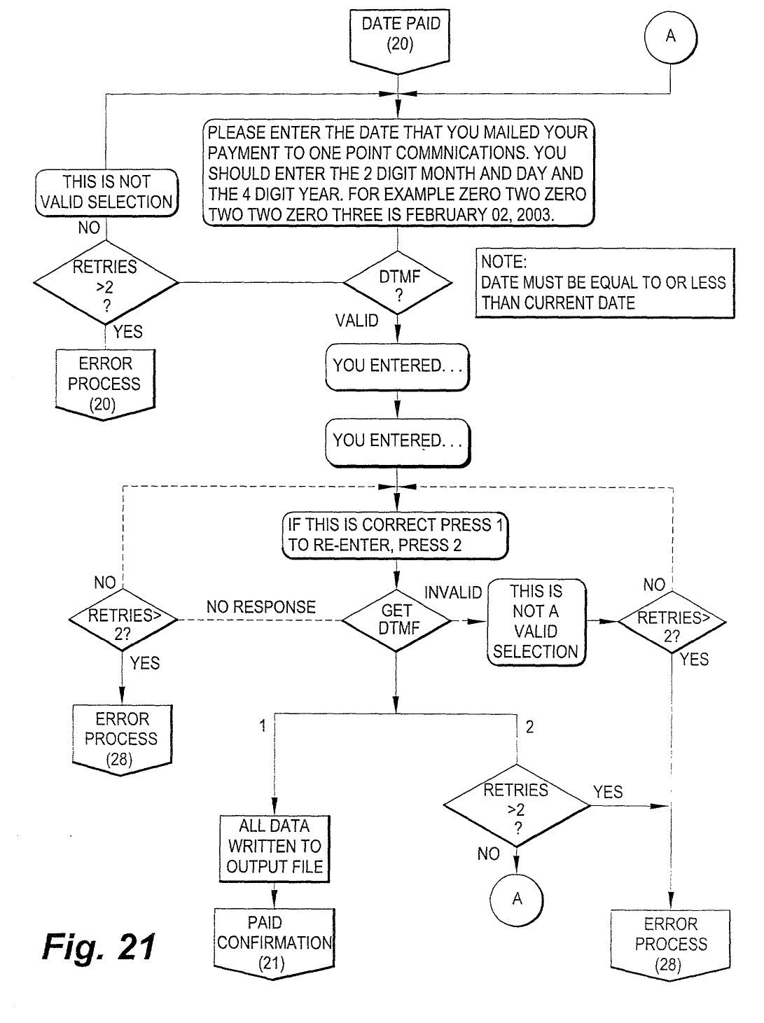

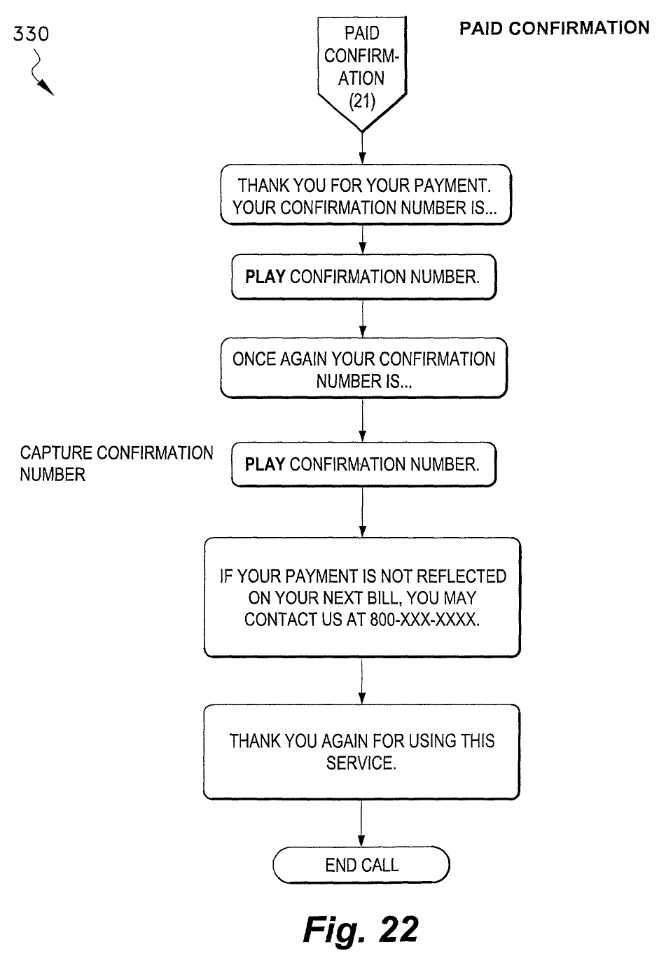

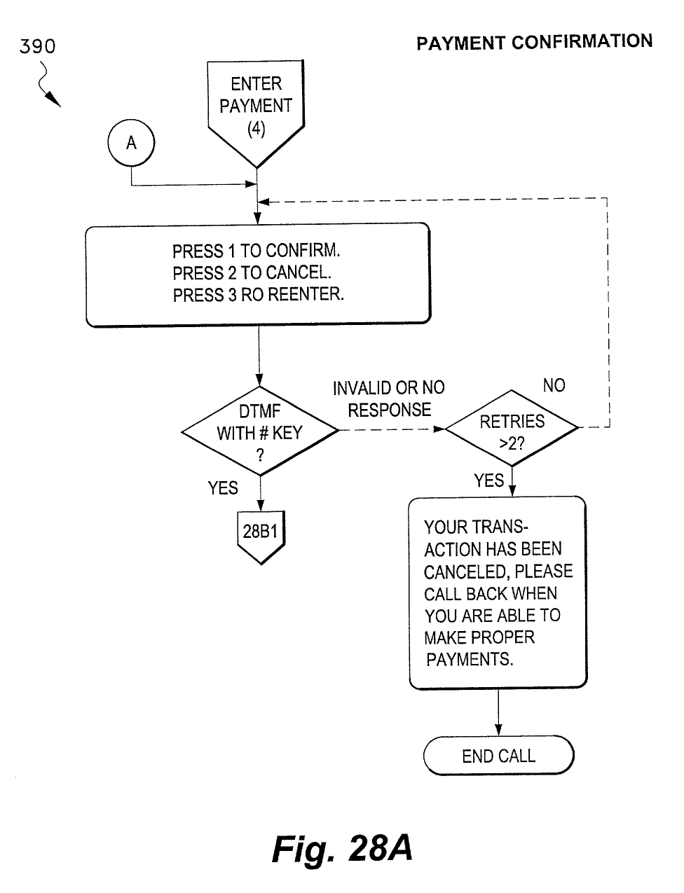

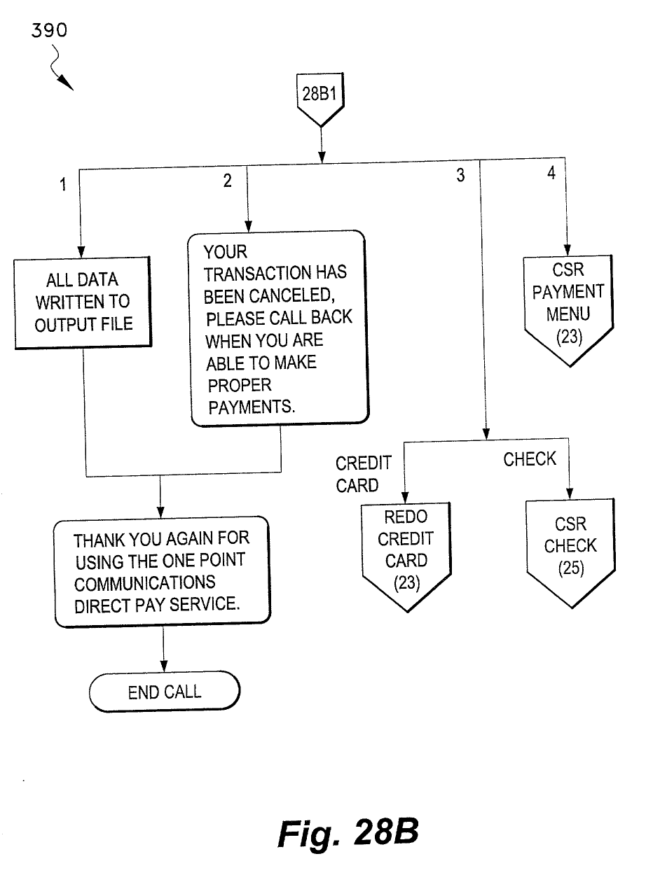

Both the payment amount and payment date are confirmed 290 again using the steps in FIGS. 18A-18B. This confirmation is in addition to the confirmations done in previous figures. Confirmation is also done using a DTMF keypad, and if a number is entered that is not a valid number, the customer 20 gets two retries before his call is ended. This process continues in FIG. 19, FIG. 20 and FIG. 21, where the balance due 300, already sent, payment 310 and date of payment 320 are played back and a confirmation number is given to the customer 20. Payment confirmation steps 330 are also outlined in FIG. 22, FIG. 28 and FIG. 29 and are redundant in the system 10 by design.

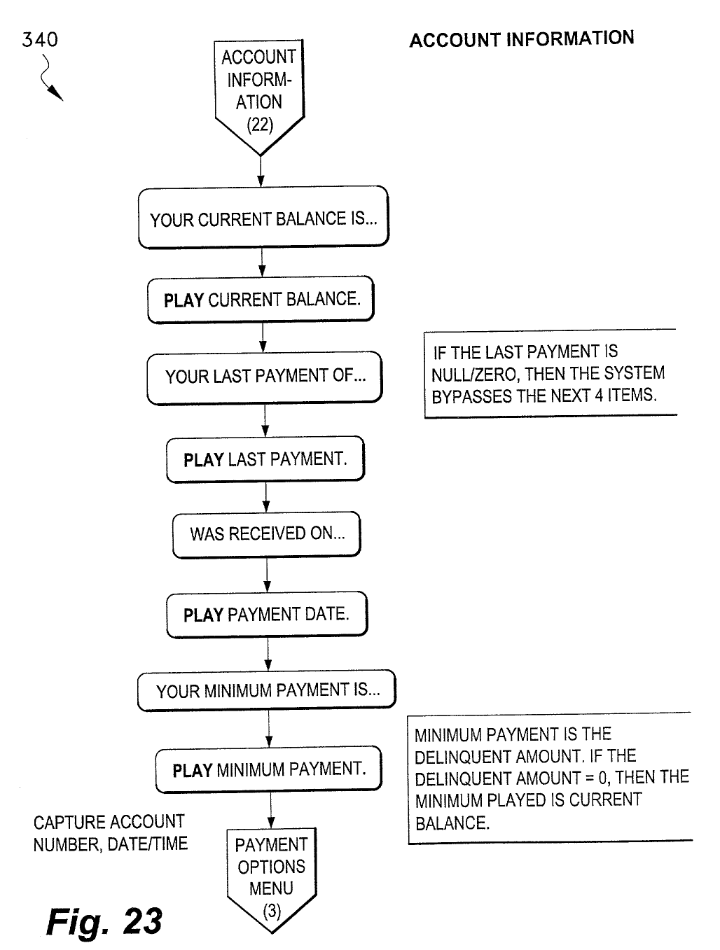

FIG. 23 outlines steps that indicate a customer's 20 account information 340. Note that if the last payment is zero, then the system 10 bypasses the next 4 items. Note that the minimum payment is the delinquent amount, and that if the delinquent amount is zero, then the minimum payment indicated is the current balance.

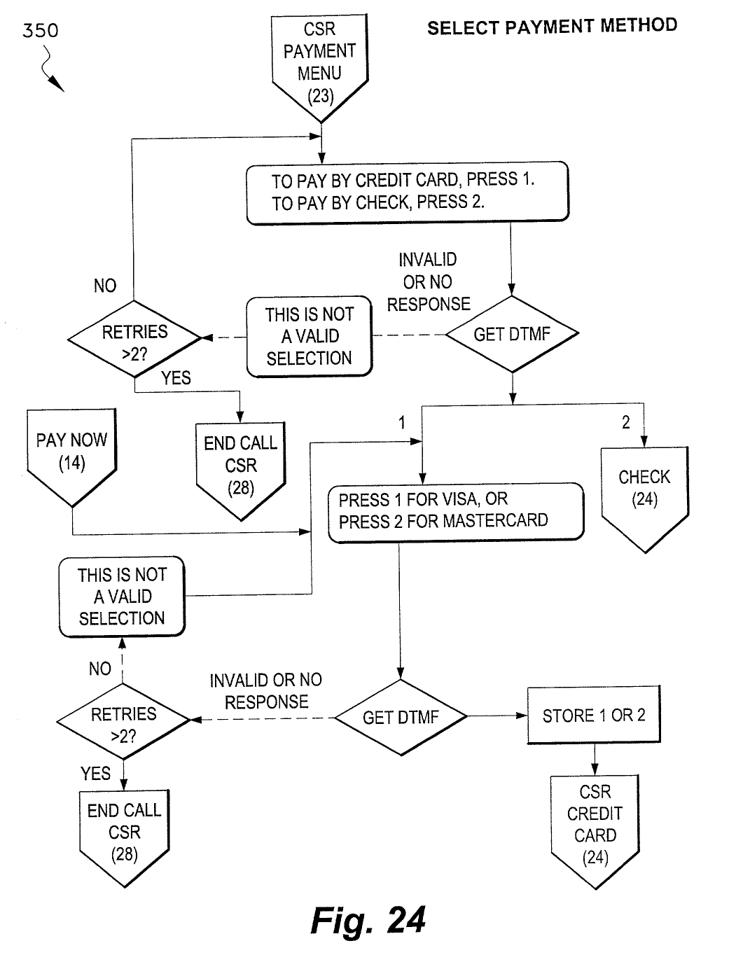

FIG. 24 is a customer service representative (CSR) menu that also requests a customer 20 to pay by credit card or check 350, using a DTMF touch pad. A DTMF touch pad is also used to indicate if the credit card being used is a Visa or Mastercard. If a number is entered that is not a valid number, the customer 20 gets two retries before his call is ended.

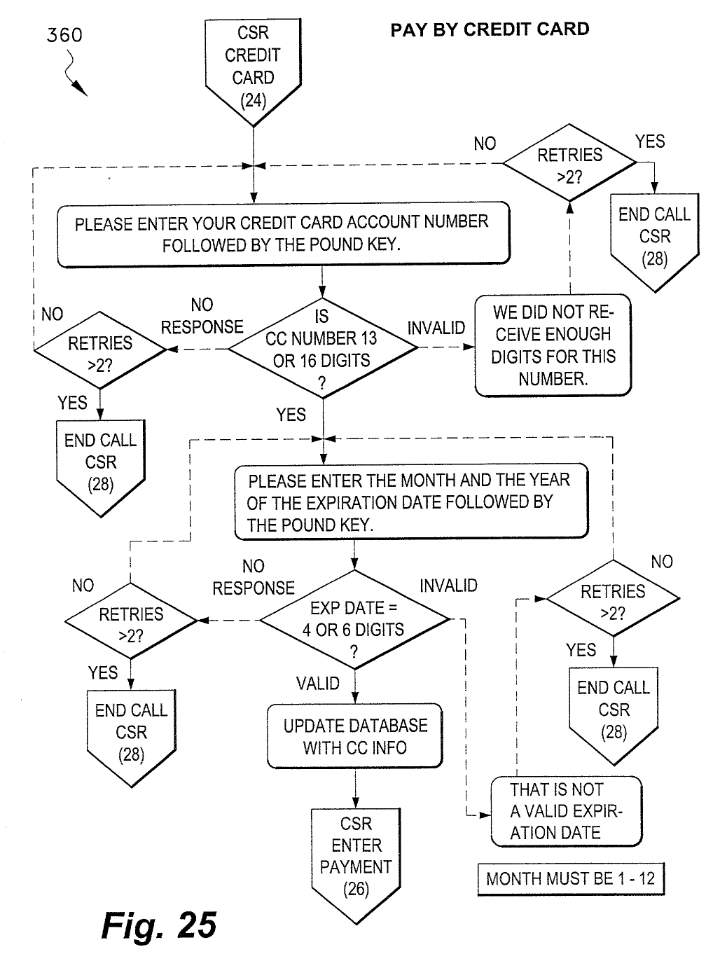

A customer 20 can continue using the system 10 by following the steps outlined in FIG. 25. These steps involve entering the credit card account number being used 360 and indicating if the credit card has 13 or 16 digits. Like most entries involved with this system 10, a DTMF touch pad is used to enter the required numerical information. The expiration date of the credit card used must also be given.

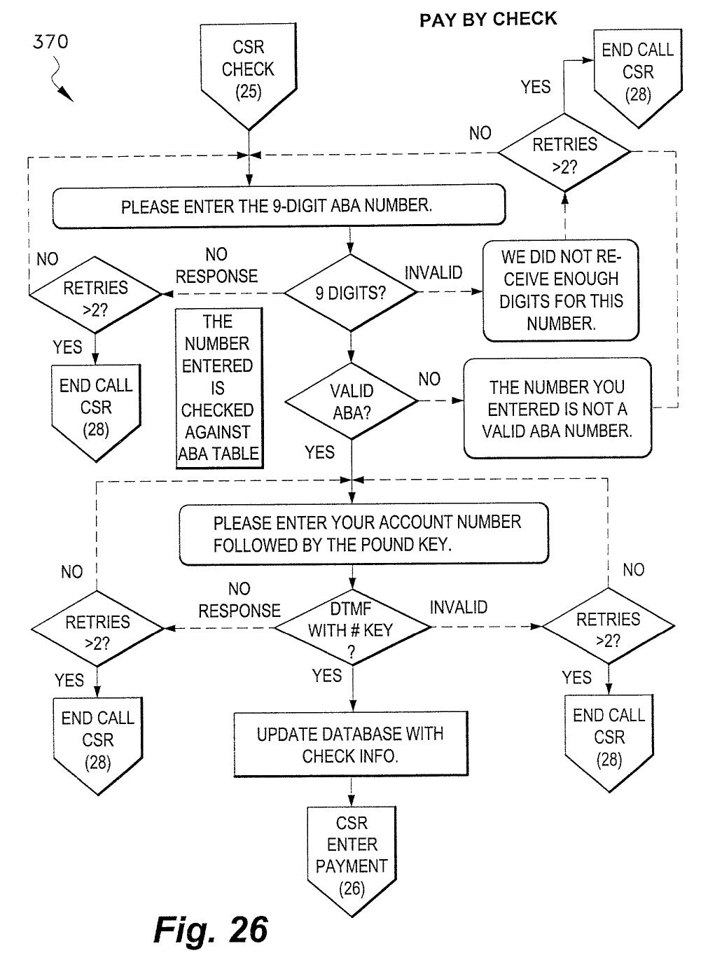

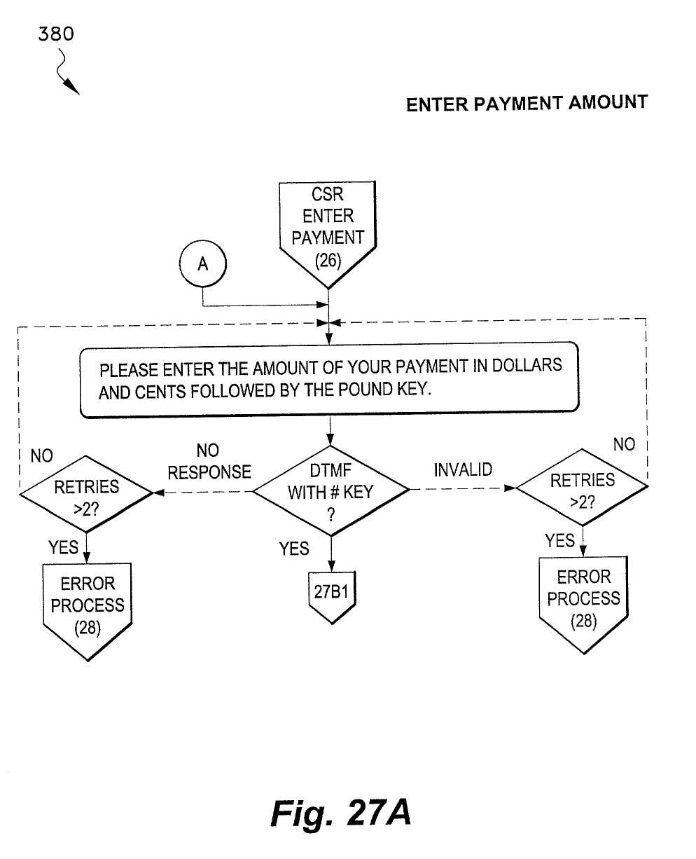

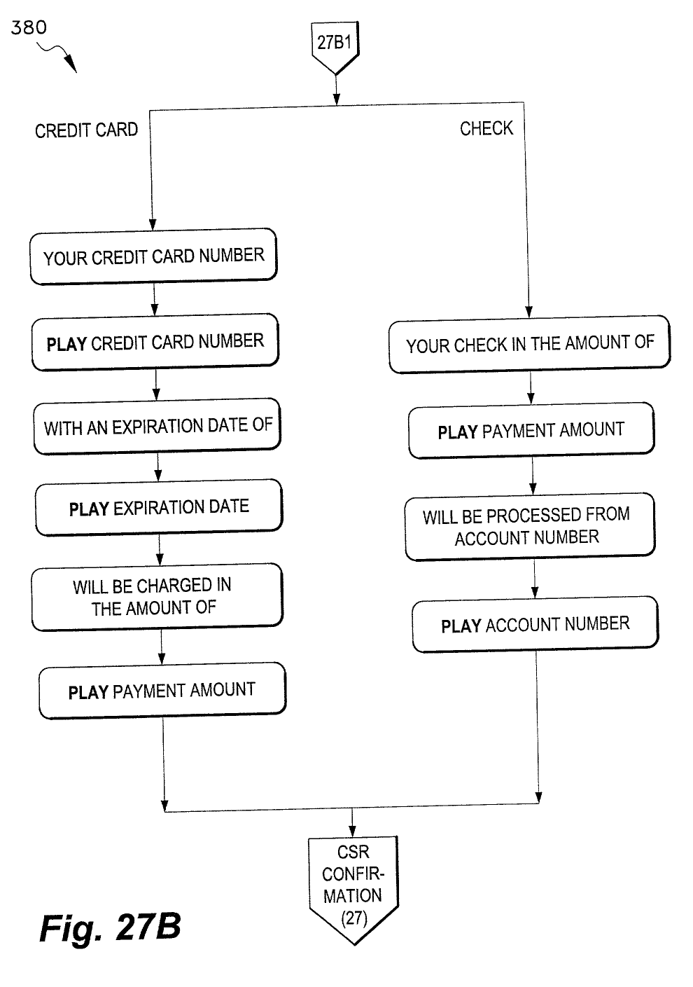

If a customer 20 desires to pay by check 370, the account number and American Banking Association (ABA) number must be entered into the system 10. These numbers entered are checked against the databases 70 and are updated if needed. These steps are similar to the steps in FIG. 10 and FIG. 11, only the databases 70 are also updated in FIG. 26. The customer 20 proceeds onto FIGS. 27A-27B, where the payment amount is entered for either the credit card or check 380. The credit card number, expiration date, the payment amount and checking account number are played back by the system 10 for the customer's 20 review. FIGS. 28A-28B and FIG. 29 are similar to the steps outlined in FIG. 19 involving payment confirmation 390 and terminating the inbound calling customer's call 400.

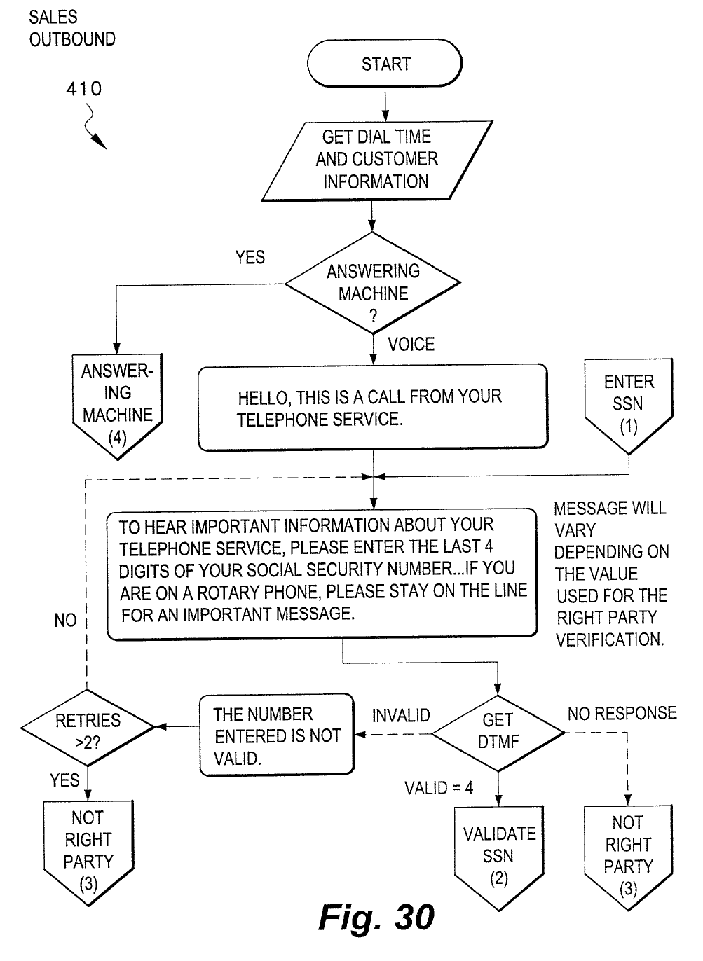

All of the figures discussed so far pertain to a customer 20 that calls into the system 10 for customer service questions or with a desire to buy a product or service. The system 10, however, is also capable of conducting collections or service calls, as are shown in FIG. 30 through FIG. 40.

FIG. 30 through FIG. 36 outlines the steps used by the system 10 to conduct outbound telephone sales calls. An automated payment retrieval method for managing payment retrievals and processing for an outbound service, comprises the steps of starting an outbound service communication session, determining if the correct outbound service customer is reached, determining if an outbound service customer's answering machine is reached and confirming and changing any outbound sales customer's 20 information.

The system 10 will get a customer's 20 information from the database 70 and dial the customer's 20 telephone number automatically to start the outbound service communication session. A scripted message is sent to the customer 20 with the possible results of the call being noted. Provisions are made for dialing the wrong number, getting a busy signal, receiving no answer, getting an answering machine, receiving a fax and getting a voice mail.

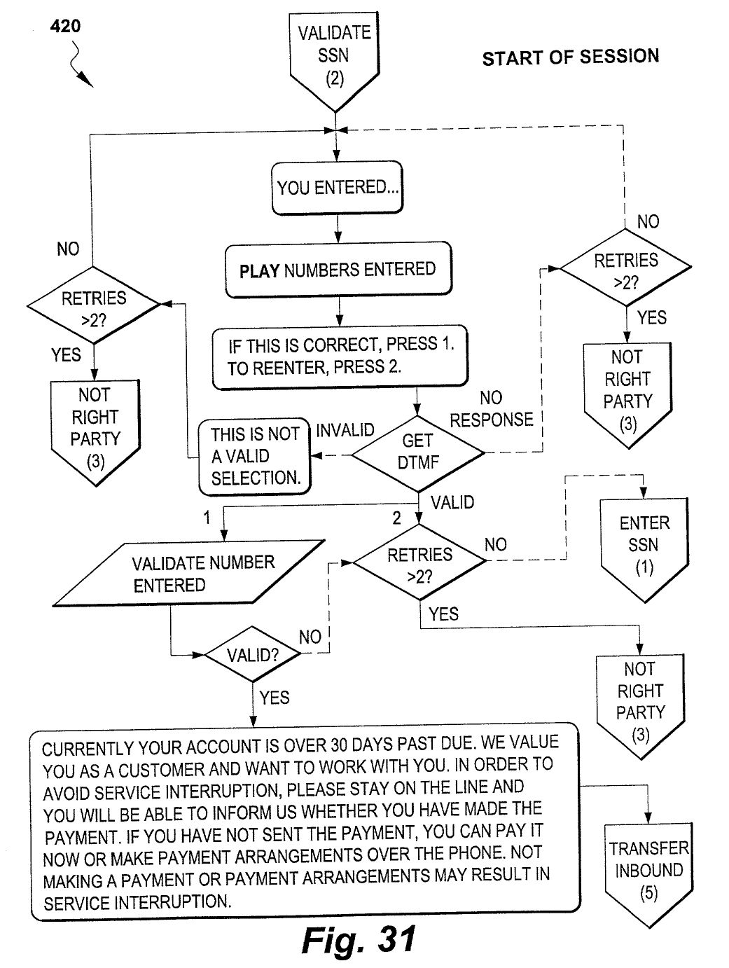

If the intended person answers the call, the scripted greeting is played and the person is asked to enter the last 4 digits of their Social Security number to verify themselves 410, as shown in FIG. 30. Non-DTMF rotatory phone users simply stay on the line and are assisted by an operator. The customer's 20 social security number is validated 420 by the system 10 and is confirmed by DTMF signal, as shown by the steps in FIG. 31. During validation, if a number is entered that is not a valid number, the customer 20 gets two retries before his call is ended.

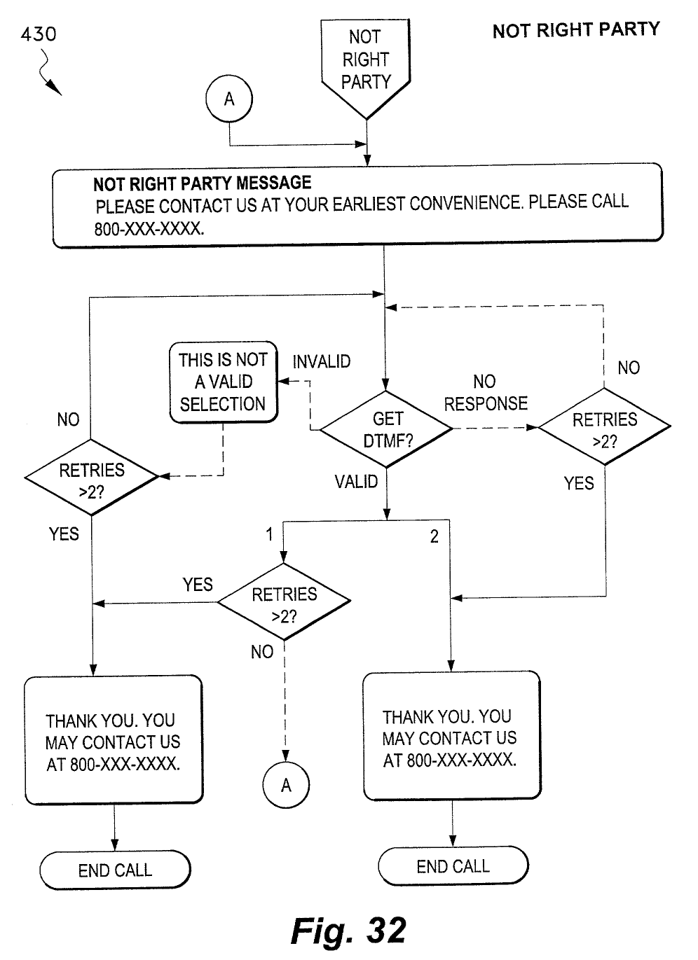

Once the customer's 20 Social Security number is captured, the system 10 confirms service, changes or inquires about missing information from the system 10. FIG. 32 depicts the steps taken when the wrong number (not right party) is dialed 430. A message is played by the system 10 asking the recipient to contact the system 10 at a given 1-800 number, and the call is ended. When the call is returned, a correction is made to remove the wrong number from the system 10.

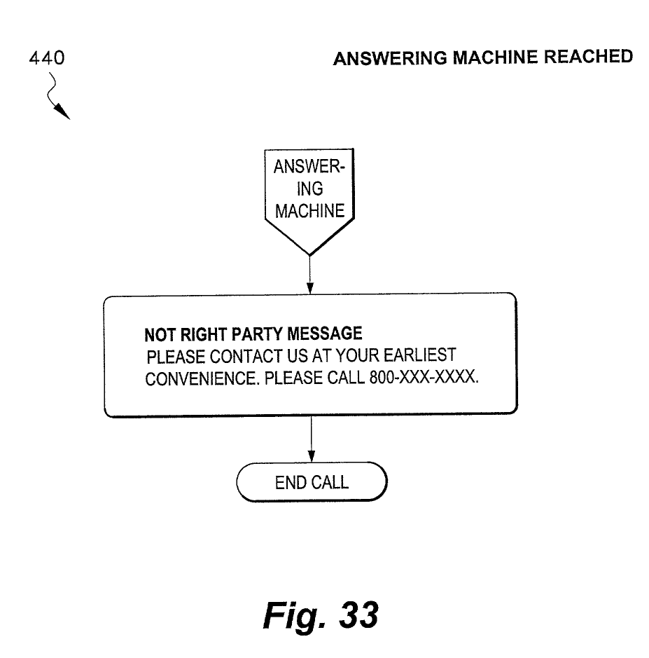

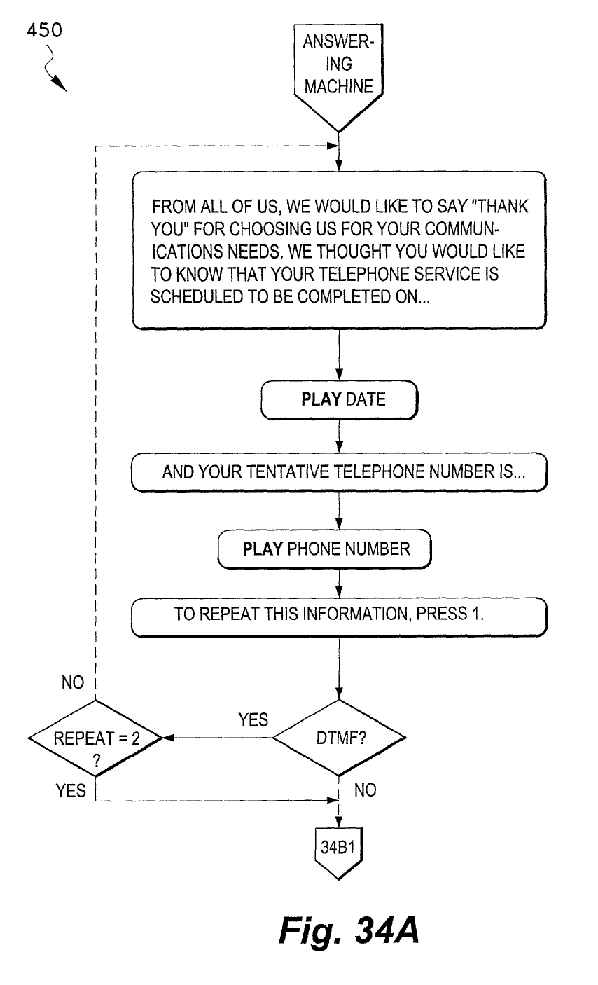

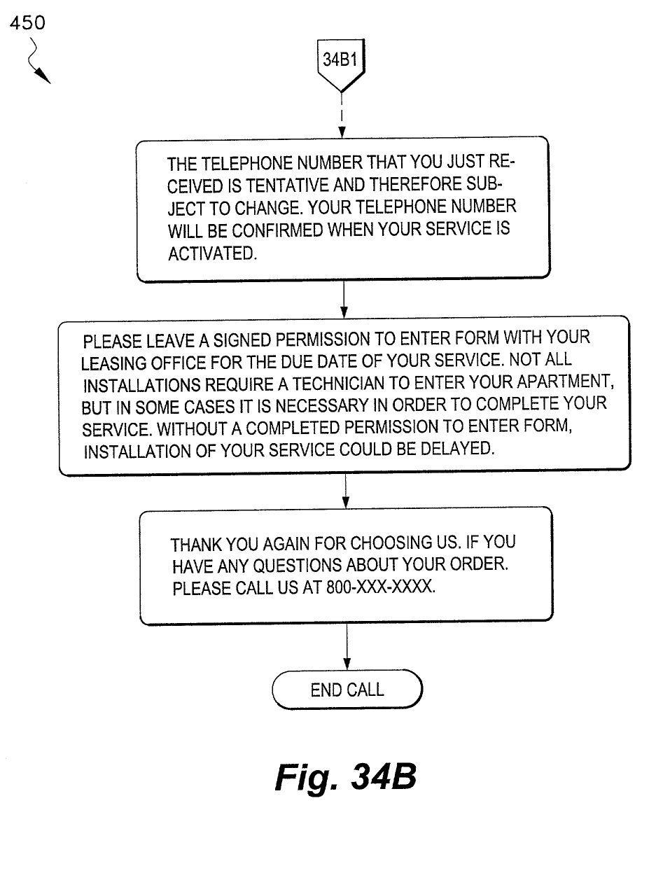

FIG. 33 similarly outlines the steps taken when the system 10 reaches an answering machine 440. As indicated, the system 10 leaves a message on the answering machine 440 to contact the system 10 at a given 1-800 number. The call is then ended. FIGS. 34A-34B outline the steps taken by the system 10 to confirm future telephone service 450 for a customer 20. A message leaving a tentative phone number and a request for a “permission to enter” form is played for a customer 20. The tentative phone number is subject to change and the permanent phone number will be confirmed when the service is activated.

The “permission to enter” form is needed for service that requires a technician to enter a premises. Note that not all service requires entrance to a premises, but getting the permission to enter ahead of time prevents a possible delay.

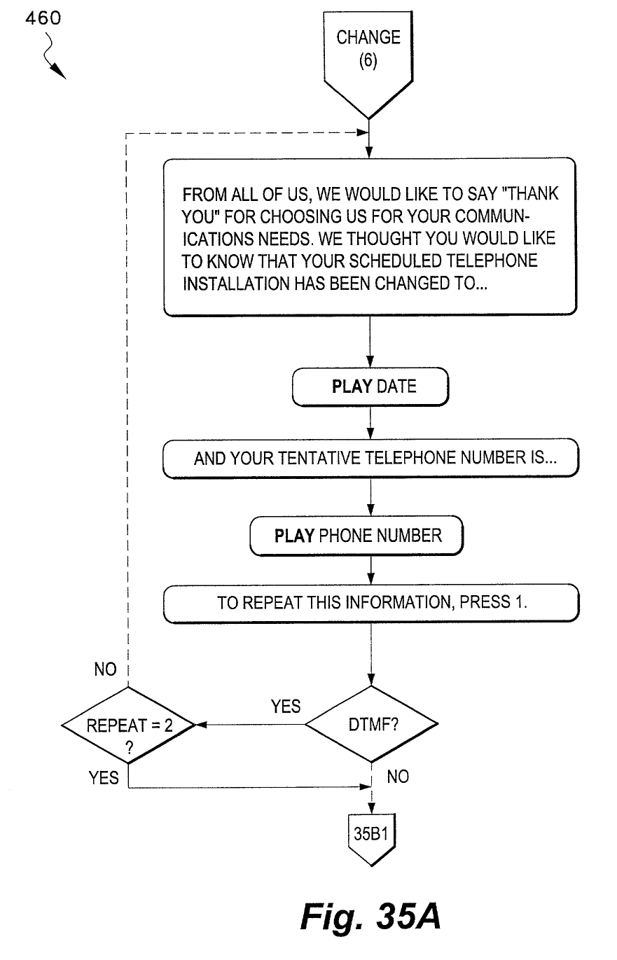

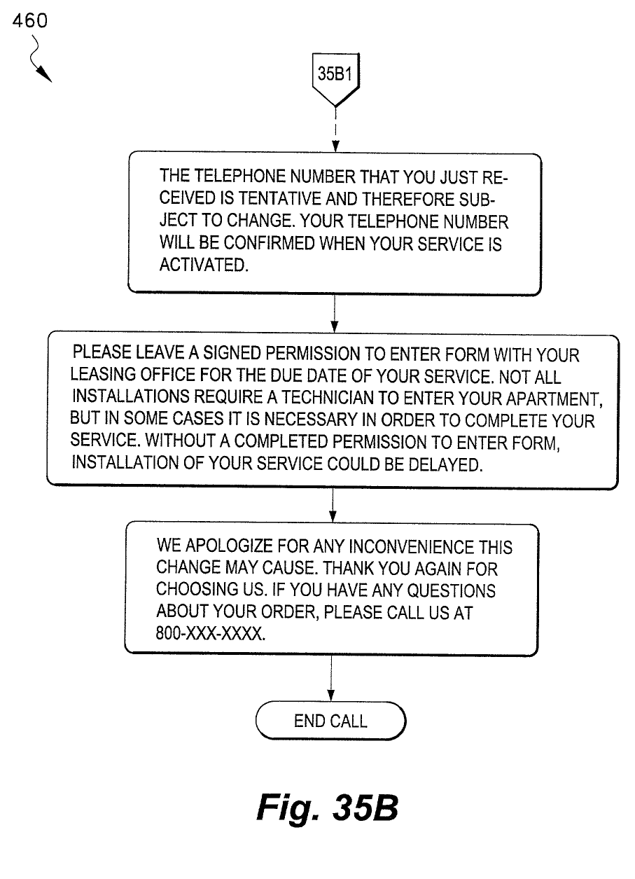

FIGS. 35A-35B outline the steps needed to change any scheduled telephone service 460. Similarly to FIGS. 34A-34B, a tentative phone number is given to the customer 20 and a request for a “permission to enter” form is provided as well as a message that the service has been changed from one date to another. This information can be repeated for the customer 20 using a number on the DTMF touch pad if needed. Questions can also be addressed at the 1-800 number given.

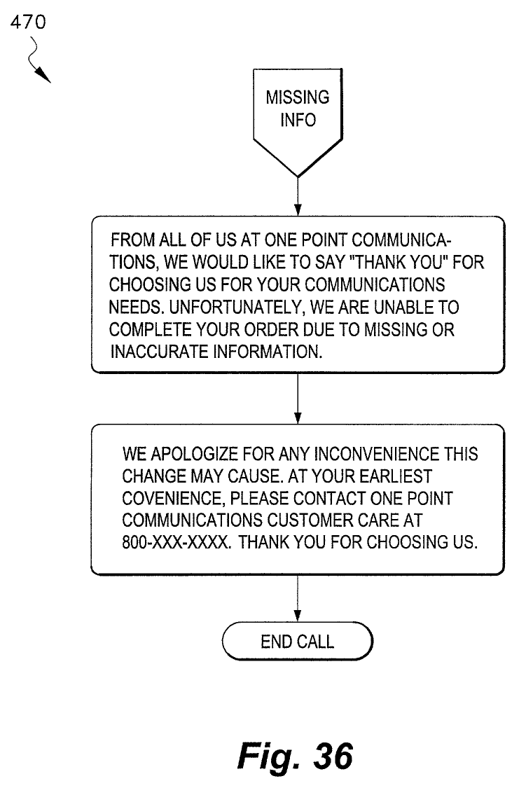

FIG. 36 outlines the steps taken for providing any missing information 470 to the system 10. A message requesting additional information is played for the customer 20 and a telephone number is given to contact the system 10 regarding this missing information. The call is then ended.

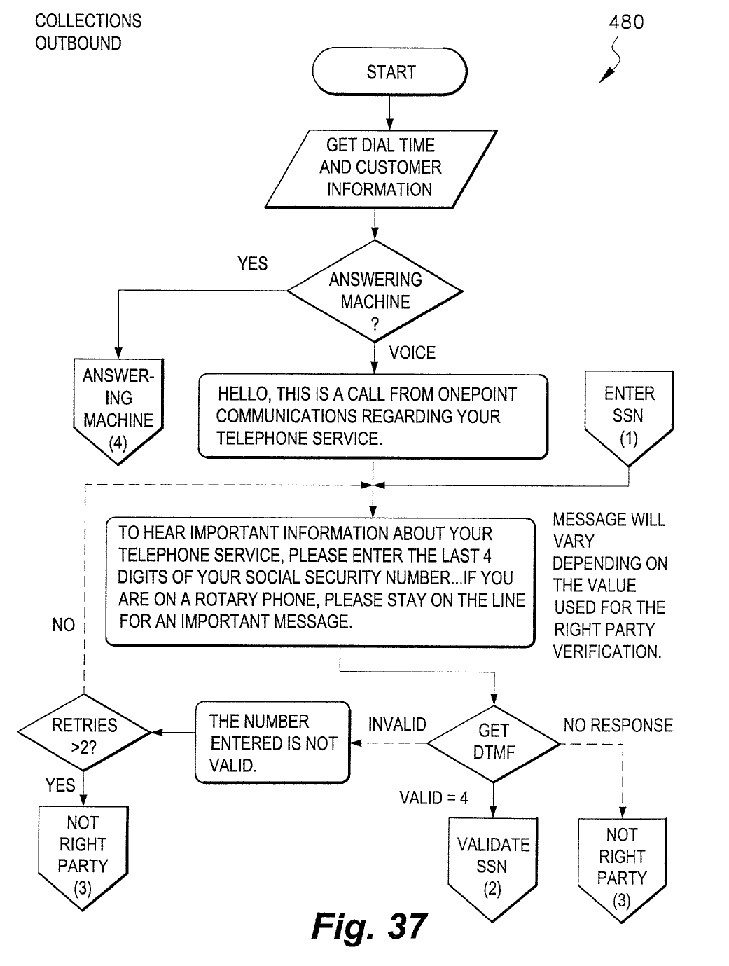

FIG. 37 through FIG. 40 outline an automated payment retrieval method for managing payment retrievals and processing for an outbound collections customer, comprising the steps of starting an outbound collections communication session, determining if the correct outbound collections customer is reached and determining if an outbound collections customer's answering machine is reached.

The system 10 will get a customer's 20 information from the database 70 and dial the customer's 20 telephone number automatically to start the outbound service communication session. A scripted message is sent to the customer 20 with the possible results of the call being noted. Provisions are made for dialing the wrong number, getting a busy signal, receiving no answer, getting an answering machine, receiving a fax and getting a voice mail.

If the intended person answers the call, the scripted greeting is played and the person is asked to enter the last 4 digits of their Social Security number to verify themselves. Non-DTMF rotatory phone users simply stay on the line and are assisted by an operator. The customer's 20 social security number is validated by the system 10 and is confirmed by DTMF signal 480, as shown by the steps in FIG. 37. During validation, if a number is entered that is not a valid number, the customer 20 gets two retries before his call is ended.

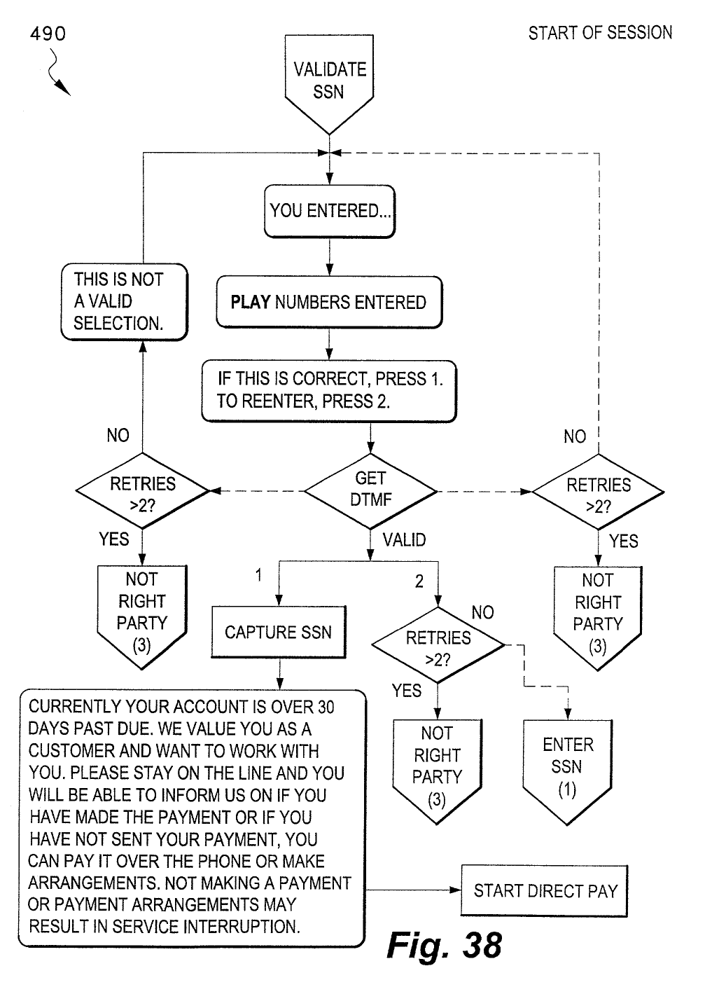

The start of an outbound collections session follows the validation 490 and is outlined in FIG. 38. Once validated, a past due message is given to the customer 20, the customer 20 is asked to stay on the line and indicate if payment arrangements have been made or to make payment arrangements at this time. The direct payment steps start from FIG. 2 and result in the customer 20 making an immediate payment or setting up a definitive payment arrangement.

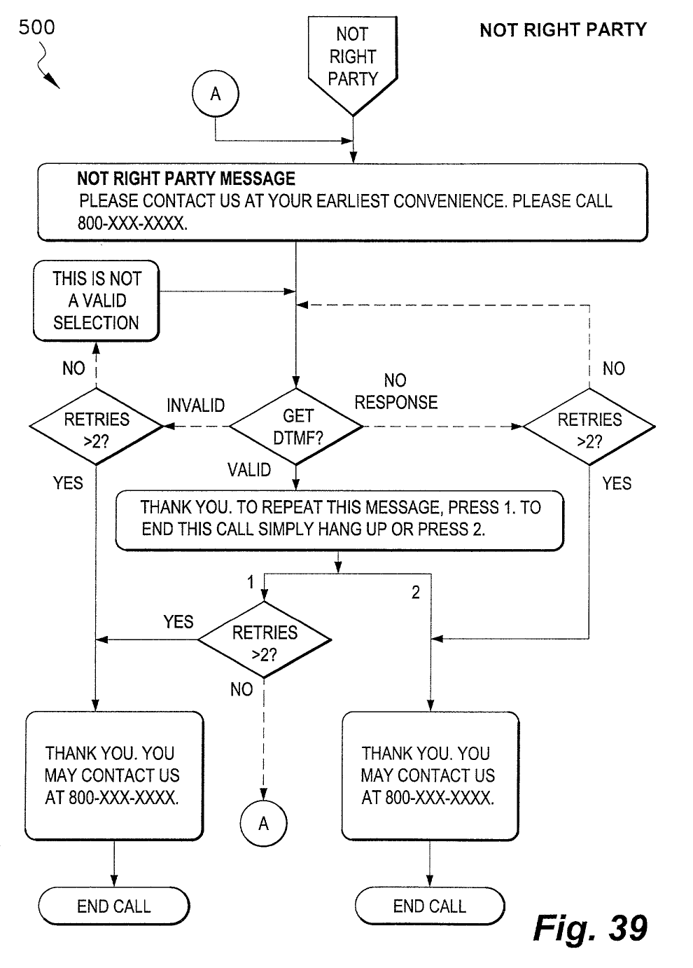

FIG. 39 depicts the steps taken when the wrong number (not right party) is dialed 500. A message is played by the system 10 asking the recipient to contact the system 10 at a given 1-800 number, and the call is ended. When the call is returned, a correction is made to remove the wrong number from the system 10. During validation, if a number is entered that is not a valid number, the customer 20 gets two retries before his call is ended.

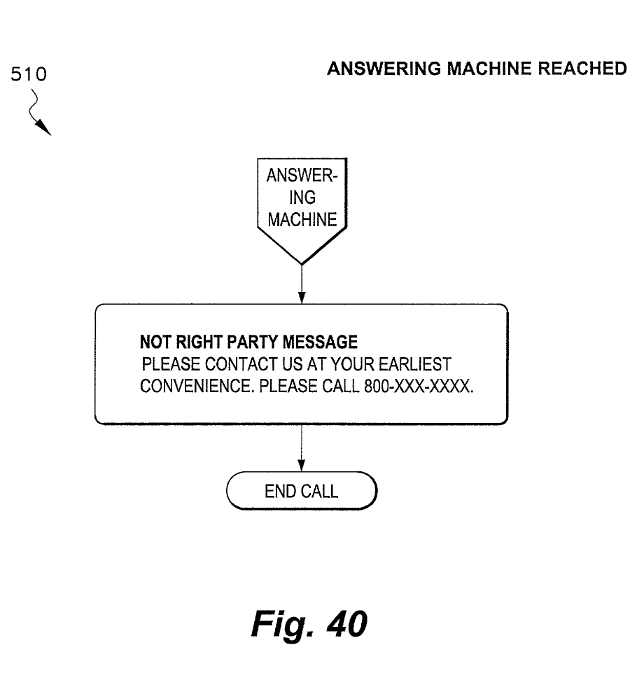

If an answering machine is reached, the steps from FIG. 40 are taken. FIG. 40 similarly outlines the steps taken when the system 10 reaches an answering machine 510. As indicated, the system 10 leaves a message on the answering machine to contact the system 10 at a given 1-800 number. The call is then ended.

Operation of the system 10 is straightforward. The system 10 is a flexible, interactive collection tool designed and developed to handle both inbound and outbound calls. It's call flow and pre-scripted prompts help gather promises to pay debts in full, create approved payment schedules for the customer 20, indicate they have already sent in a payment to avoid disconnection and check their account history by entering responses using their DTMF keypad. This in turn, allows customer service representatives to focus on more complex customer service issues. The main goal of the system 10 is to increase debt recovery, while lowering the cost per dollar recovered.

Customers 20 are identified by entering an identification number (such as a telephone number or the last 4 digits of a Social Security number), with the option of transferring to a live customer service person. Once the right party contact is confirmed, account information is pulled from the host databases 70, which will reside on the system 10, or on remote host databases 70 hooked up via standard transmission control protocol/Internet protocol (TCP/IP). The system 10 reviews the amount owed and tries to obtain a payment by check or credit card or at a bare minimum, a promise to pay, requesting payment in full or offering a monthly payment arrangement.

When a customer 20 makes a promise to pay, the information is transferred to one of the host databases 70, which updates the customer's 20 record and generates a confirmation letter (usually sent out later that day). Customers 20 can also enter dispute reasons during the call and have the ability to transfer to a live customer service representative during normal business hours. If the call is transferred, data captured by the system 10 can be transferred along with it. This includes called number direct inward dialing/dialed number identification service (DID/DNIS), caller ID, automatic number identification (ANI) information, which is obtained from the private branch exchange (PBX) and passed to the database 70 host.

The system 10 is capable of processing inbound and outbound calls simultaneously or as defined by the system administrator while communicating with the database 70 host for information retrievals and updates. The system 10 was developed to interface a host database 70 using TCP/IP through a local area network (LAN). This results in real-time uploads and downloads of customer 20 information to the databases 70. Data activity of a campaign include the number of promises to pay, payment type, already paid information where customers 20 indicate that they have already sent in a payment and other account retrieval. In addition, ASCII reports may be generated which can be imported into third-party programs for additional analysis.

It is to be understood that the present invention is not limited to the sole embodiment described above, but encompasses any and all embodiments within the scope of the following claims.

We claim:

1. An automated payment retrieval system for managing payment retrievals and processing for a plurality of customers, comprising:
a plurality of primary servers and back up servers for responding to commands from a plurality of customers;
a central processing unit (CPU) for interpreting and executing instructions;
a plurality of dialogic analog cards for receiving and transmitting inbound and outbound telephone calls for the system;
a plurality of databases for storing information about customer lists, customers' American Banking Association (ABA) numbers, delinquent customer lists and sales customers lists;
interactive voice response (IVR) software for processing inbound and outbound telephone calls;
automated clearing house (ACH) software for processing information sent to and received from an automated clearing house (ACH);
a pretty good privacy (PGP) server and program for public key encryption; and
credit card verification and processing software.

2. The automated payment retrieval system for managing payment retrievals and processing for a plurality of customers, according to claim 1, wherein said plurality of databases communicate with the rest of the system using TCP/IP technology over the Internet.

3. The automated payment retrieval system for managing payment retrievals and processing for a plurality of customers, according to claim 1, wherein said system has ASCII report capability.

4. An automated payment retrieval method for managing payment retrievals and processing for an inbound calling customer, comprising the steps of:
starting an inbound communication session;
validating an inbound calling customer's telephone number;
selecting a payment method and a payment amount;
entering a minimum payment amount;
paying by credit card and obtaining the expiration of the credit card;
paying by check and entering a checking account number;
summarizing a payment recap and payment confirmation;
negotiating and arranging a payment schedule with a minimum payment, a negotiated minimum payment and a payment date;
providing a payment confirmation;
providing customer's account information such as a balance due, already sent payment information, payment method and payment amount; and
terminating the inbound communication session.

5. An automated payment retrieval method for managing payment retrievals and processing for an outbound service customer, comprising the steps of:
starting an outbound service communication session;
determining if the correct outbound service customer is reached;
determining if an outbound service customer's answering machine is reached; and
confirming and changing any outbound service customer's information.

6. An automated payment retrieval method for managing payment retrievals and processing for an outbound collections customer, comprising the steps of:
starting an outbound collections communication session;
determining if the correct outbound collections customer is reached; and
determining if an outbound collections customer's answering machine is reached.
